(19) United States
(12) Patent Application Publication
(10) Pub. No.: US 2019/0132415 A1
(43) Pub. Date: May 2, 2019

(54) ACTIVE DATA MANAGEMENT BY FLEXIBLE ROUTING SYSTEM AND METHODS OF AN ACCELERATED APPLICATION-ORIENTED MIDDLEWARE LAYER

(71) Applicants: Srinivasan Viswanathan, Fremont, CA (US); Jagannathdas Rath, Bengaluru (IN)

(72) Inventors: Srinivasan Viswanathan, Fremont, CA (US); Jagannathdas Rath, Bengaluru (IN)

(21) Appl. No.: 15/970,215

(22) Filed: May 3, 2018

Related U.S. Application Data
(63) Continuation-in-part of application No. 15/222,918, filed on Jul. 28, 2016, now Pat. No. 10,013,185.
Application No. 15/222,918 is a continuation-in-part of application No. 14/214,611, filed on Mar. 14, 2014, now Pat. No. 9,432,485.
(60) Provisional application No. 61/793,228, filed on Mar. 15, 2013.

(51) Int. Cl. H04L 29/08; H04L 12/725

(52) U.S. Cl. CPC H04L 67/2852; H04L 67/1097; H04L 45/30

(57) ABSTRACT

In an aspect, a computer-implemented method for managing active read and write data routing and placement policy overview in an application-oriented system comprising: when an application issues a write operation, a writeback system of the application-oriented system writes the data only in the Virtual Element (VE) of the cache Virtual Storage Objects (VSTO) and not on another capacity layer VSTO; when an application issues an attribute write operation or metadata write operation, a writeback system of the application oriented system executes the attribute write operation in an appropriate Meta chunk Virtual Element (VE) of the cache VSTO only and not on another capacity layer VSTO; and persistently implementing a metadata change only in the Meta chunk VE.

### CROSS REFERENCE TO RELATED APPLICATIONS

This application claims the benefit of priority from U.S. Provisional Application Ser. No. 61/793,228, which was filed on Mar. 15, 2013, and U.S. patent application Ser. No. 14/214,611, which was filed on Mar. 14, 2014, and U.S. patent application Ser. No. 15/222,918 which was filed on Jul. 28, 2016, and which are each expressly incorporated by reference herein in their entirety.

### BACKGROUND

Conventional systems for managing data may have limitations with respect to retrieving and accessing data. Improvements may be made that increase speed while maintaining reliability.

### SUMMARY

In an aspect, a computer-implemented method for managing active read and write data routing and placement policy overview in an application-oriented system comprising: when an application issues a write operation, a writeback system of the application-oriented system writes the data only in the Virtual Element (VE) of the cache Virtual Storage Objects (VSTO) and not on another capacity layer VSTO; when an application issues an attribute write operation or metadata write operation, a writeback system of the application oriented system executes the attribute write operation in an appropriate Meta chunk Virtual Element (VE) of the cache VSTO only and not on another capacity layer VSTO; and persistently implementing a metadata change only in the Meta chunk VE; when an application issues a read operation, a writeback system of the application oriented system intelligently detects and segregates the dirty and non-dirty data ranges in the read operation and routes them to cache VSTO and capacity layer VSTO as separate read sub-operations respectively; and when an application issues a metadata or attribute read operation, the system would route the operation to one of the Cache VSTOs or Capacity layer VSTOs depending on whether the file or inode was already cached or not.

### BRIEF DESCRIPTION OF THE DRAWINGS

The present application can be best understood by reference to the following description taken in conjunction with the accompanying Figures, in which like parts may be referred to by like numerals.

FIG. 1 illustrates an example data management system, according to some embodiments.

FIG. 2 depicts, in block diagram format, an example data manager according to some embodiments.

FIG. 3 is a block diagram of a sample computing environment that can be utilized to implement some embodiments.

FIG. 4 is a block diagram of a sample computing environment that can be utilized to implement some embodiments.

FIG. 5 illustrates a table depicting various data object classes and corresponding allowed data types, according to some embodiments.

FIG. 6 illustrates an example middleware data management system, according to some embodiments.

FIG. 7 is a schematic diagram of a mapping system that includes a cache mapper and a passthrough mapper, according to an embodiment;

FIG. 8 is a schematic diagram of a mapping system that includes a regular or file-based mapper, according to an embodiment.

FIGS. 9 A-B illustrate an example process of writeback based input output system and methods of an accelerated application-oriented middleware layer, according to some embodiments.

FIG. 10 illustrates an example process for writeback policy overview, according to some embodiments.

FIG. 11 illustrates an example process for writeback policy for i/o operations, according to some embodiments.

FIGS. 12 A-B illustrates an example process for implementing a writeback flush sub-system, according to some embodiments.

FIGS. 13 illustrates an example process of writealways based input output system and methods of an accelerated application-oriented middleware layer, according to some embodiments.

FIGS. 14 illustrates an example process of nowrites based input output system and methods of an accelerated application-oriented middleware layer, according to some embodiments.

The Figures described above are a representative set and are not an exhaustive with respect to embodying the invention.

### DETAILED DESCRIPTION OF THE INVENTION

Although the present embodiments have been described with reference to specific example embodiments, it will be evident that various modifications and changes may be made to these embodiments without departing from the broader spirit and scope of particular example embodiments.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of structures, openings, protrusions, surfaces, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

Reference throughout this specification to “Data” “IO” “Data access” or similar language would refer to both “data access” as well as “attribute access” of a file. Attribute can comprise of various properties of the file like size, modified time, access time, owner, permission and all other such related properties of a particular file.

I. Exemplary Environment and Architecture

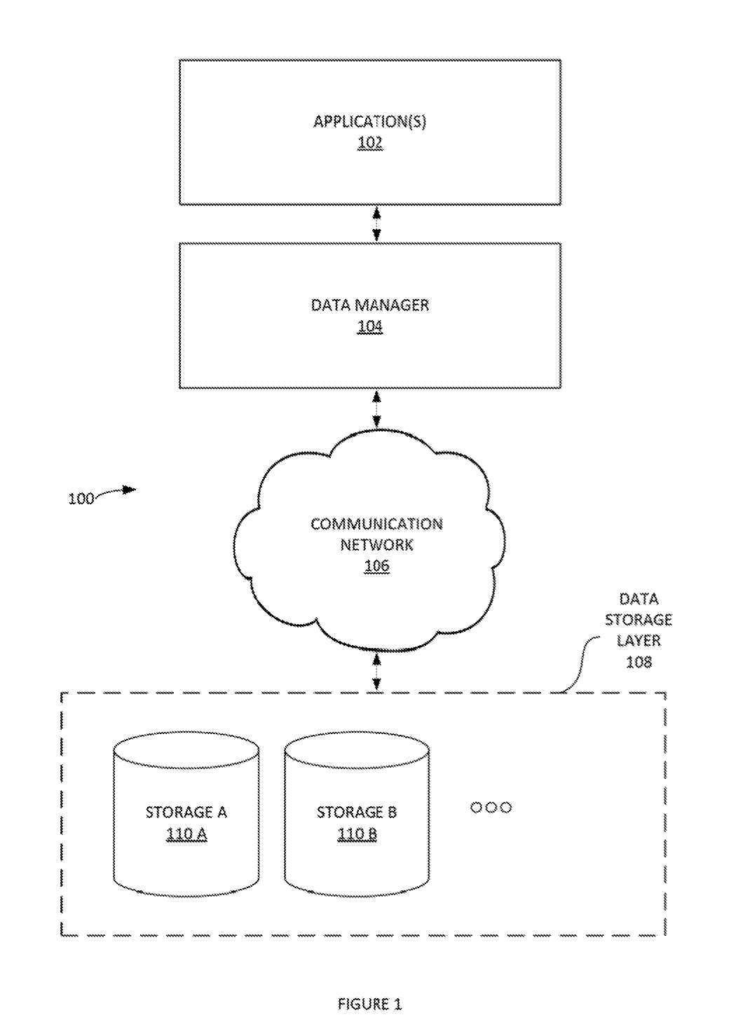

FIG. 1 illustrates an example data management system 100, according to some embodiments. In one embodiment, data manager 104 (e.g. a DATGRES® middleware platform such as the systems and methods of the FIGS. 1-12) can include a middleware layer (e.g. an application-oriented middleware layer) that enables communication and management of data between an operating system at the application(s) 102 layer and various distributed data storage applications (e.g. such as data storage and/or filesystems) in the data store layer 108. As used herein, a ‘layer’ can refer to an abstraction layer of data management system 100. As used herein, a middleware layer can include functionalities and/or systems that are between the operating system applications (e.g. application(s) 102) and a data storage layer 108 on each side of a distributed computing system in a computer network. Data manager 104 can manage data, from its origin until its deletion, taking it through the entire life cycle of growth, mobility, reliability, scalability and performance. Data manager 104 can be implemented to manage placement and/or dynamic distribution of data to satisfy any relevant service-level agreements (SLA), service-level objectives (SLO) (and the like) related to application(s) 102. Data manager 104 can provide access to a number of applications (e.g. storage 110 A-B). Communication network 106 can include various computer network systems and protocols (e.g. the Internet, database communication networks, Ethernet, etc.).

Data manager 104 can include engineering design and implementation principles related to, inter alia, the following: asynchrony/loosely coupled properties for distributed and scalable development of the features of the architecture; multi-threading to support SMP environment; instrumentation and observation of the internals of the system for support, monitoring and debugging; high performance I/O, optimized algorithms for caching, Efficient resynchronization of the objects; portability across multiple operating system (OS) versions; self-described objects and the ability to assemble them together on-demand as and when they arrive; command-line utilities that form the basis of development and customer interactions; high availability (HA) features of hardening, disconnected operations, and clustered deployments; multi-tenant architectural properties of resource management, isolation, and security; ease of installation and upgrades; reliability of persistent data structures and meta data management; multi-level debugging ability with dynamic on/off of various levels both at user level and system level; verification of the deployed configurations, and integrity of the data; various Data Collection Policies via monitoring of the system from fine grained to coarse grained collection; intelligent analytics of the data collected at both fine and coarse grained level; related reporting for knowledge management, conclusions and feedback loop; ability to build scalable data center based abstractions of logical domains, storage spaces, grid analytics; integrated health management of the services; event notifications from kernel to help address the dynamic state changes in the system; in-built tools/primitives for building intelligent test framework and backdoor verifications; distribution abstractions of the objects for ease of use and management; and accounting to keep the block calculations of alloc/free, space policies, etc., consistent across multiple shared large no. of objects on heterogeneous elements.

It is noted that the systems and methods provided in FIG. 1 and subsequent figures disclose embodiments for implementation in a database system. However, additional implementations in various applications that utilizes data and data storage can be implemented. Several additional use cases are now provided by way of example. The systems and methods of the Figures can be modified according to each use case. In one example, the systems and methods of the FIGS. 1-12 can be implemented in media and render farm applications (e.g. MAYA 3D®, AUTODESK®, BLENDER®, etc.) for processing and rendering of animations, special effects, layer impositions on various movies and other similar videos. These applications can have Petabytes of data coming from Network File Systems. The ‘hot’ data can be cached on local drives, thereby drastically reducing their data access time. This can also lead to faster completion of the jobs. As used herein, ‘hot’ data can refer to frequently accessed data. Hot data typically can be set at a good cache-hit rate.

In another example, the systems and methods of the FIGS. 1-12 can be implemented in E-CAD applications (e.g. Autodesk®, Stylus®, etc.). For example, local caching of hot data can be implemented in applications such as chip designing, motherboard designing, and fabrication of chips and other related work.

In another example, the systems and methods of the FIGS. 1-12 can be implemented in database solutions (MySQL®, PostgrSQL® etc.). For example, database access can be accelerated by the data acceleration and caching system which leads to reduction in latency of access and increase in number of Transactions per Second (TPS).

In another example, the systems and methods of the FIGS. 1-12 can be implemented in file servers (e.g. server data to end users remotely). For example, the hot data can be cached by data management system 100 leading to faster access by users.

In another example, the systems and methods of the FIGS. 1-12 can be implemented in web servers (e.g. webserver like Apache, Tomcat etc.). For example, similar to file servers, but there the web content is cached by data management system 100 and served from cache devices resulting in faster loading of web page documents.

In another example, the systems and methods of the FIGS. 1-12 can be implemented in various proprietary applications. For example, any application designed and developed by any individual/organization, which accesses data from a local device and/or an NFS Share, can be accelerated by data management system 100 resulting in a great boost in application performance.

In another example, the systems and methods of the FIGS. 1-12 can be implemented in email servers (e.g. Zimbra, etc.). For example, data management system 100 can accelerate email servers by caching the hot data (e.g. comprises email and its metadata) thereby leading to a faster email access.

In another example, the systems and methods of the FIGS. 1-12 can be implemented in virtualization environments (e.g. Xen, KVM, etc.). The hot areas of the virtual machines (VM) can be cached by data management system 100 thereby resulting in faster VMs and/or allowing more VMs to be accommodated in the same physical server.

For example, an entire set of application data can be replicated and distributed partially or wholly synchronously or asynchronously across a bunch of heterogeneous file systems or storage servers, both on LAN and/or WAN. The set of storage servers could be any of network or local file systems or network or local block devices. These servers can reside in the LAN environment or WAN. Big data mining applications can use the platform provided herein to distribute, in a scalable manner, and access the data in a high performing, reliable way between distributed enterprises or service providers. Customers wanting to remove vendor lock in can replicate their data between boxes of two different vendors using the systems provided herein. An analytics feature of the systems provided herein can provide an efficient loop back mechanism from applications to the IT architecture fine tuning.

In general, data management system 100 can boost performance of an application that has its data coming from a local device (e.g. EXT3, EXT4, XFS) and/or an NFS network share or other kinds of Network based file systems like CIFS or Object Storage Systems like Ceph, Amazon S3 to name a few but not limited to.

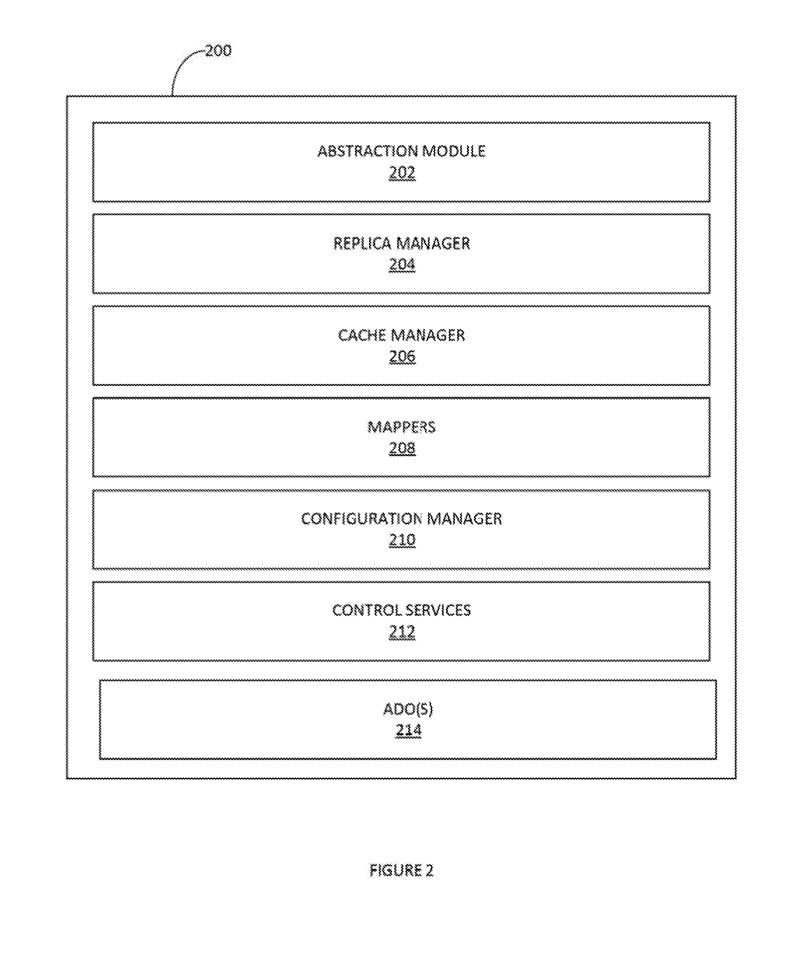

FIG. 2 depicts, in block diagram format, an example data manager 200 according to some embodiments. In some embodiments, data manager 200 can implement data manager 104 in FIG. 1. Data manager 200 can interface client-side applications (e.g. via one or more application program interfaces (APIs).

Data manager 200 can include abstraction module 202. Abstraction module 202 can abstract heterogeneous data elements (e.g. third extended file system (ext3), Network File system (NFS), Object Storage Systems (Amazon S3, Ceph) etc.) into as storage objects (STO). A data element can be an atomic unit of data. Heterogeneous data elements can have different characteristics and formats such as data storage blocks, data files, network-attached storage (NAS) format, etc.). STOs can then be logically divided into these Virtual Storage Objects (VSTO). A VSTO can represent an instance of using a specific storage object for various purposes in the layers above it. A VSTO can have a defined interface that allows for extensible and/or scalable support for different data element types and/or protocols such as NAS, storage area network (SAN), iSCSI (Internet Small Computer System Interface protocol), Direct-attached storage (DAS), etc. A VSTO can also characterize the different properties of usage by the layers above it.

Replica manager 204 can utilize STO and VSTO objects for full and/or partial replication of data and other related operations. Replica manager 204 can view an underlying VSTO as a replica. Replica manager 204 can manage the synchronization of any distribution requests in order to satisfy the requests/requirements of the above layers. Cache manager 206 can provide a cached-version of a VSTO (e.g. a cache virtual storage object). For example, cache manager 206 can transparently stores VSTO data for various purposes, including the purpose that future requests for that data can be served faster. Mappers 208 can map various objects (e.g. STO and/or VSTO objects) between layers and also mapping the unique identifiers and/or handles of the objects to the lower layers of a data management system (such as data management system 100).

Configuration manager 210 can manage the integrity of the relationship of the objects. Configuration manager 210 can manage object creation. Configuration manager 210 can manage object deletion. Configuration manager 210 can manage dynamic transitions of object state. Configuration manager 210 can reside inside the client-device operating system's kernel. Control services 212 can be implemented in the client-device layer (e.g. user layers). Control services 212 can provide the primitives required for the data manager 200 management framework. Control servers 212 can be operatively connected with and, thus, interact with the configuration manager 210 of the client-device operating system's kernel. Control servers 212 can provide location independent interaction with the objects.

Application Data Object (ADOs) 214 can operatively connect with a client-side application and provide the file system interface for said applications. ADOs 214 can be implemented above the replication layer (e.g. as provide supra).

Data manager 200 can provide a user interface that enables a user to set various data manager 200 settings and/or parameters. Data manager 200 can further provided back-end management of the objects in co-ordination with the kernel layers.

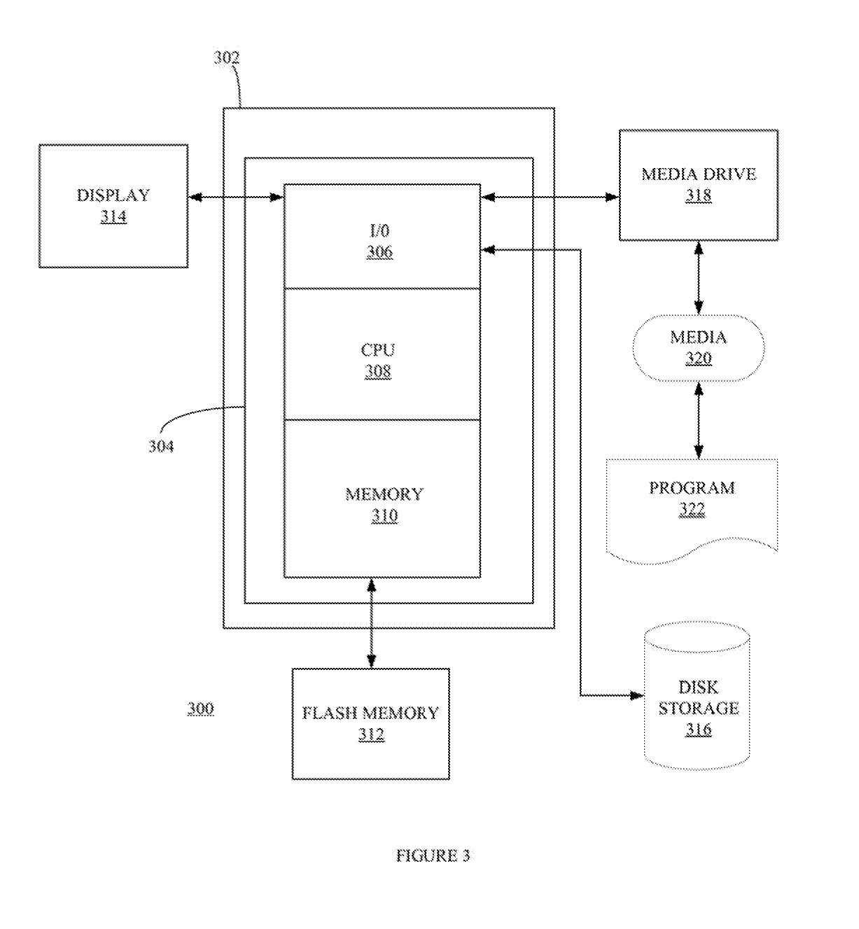

FIG. 3 depicts an exemplary computing system 300 that can be configured to perform any one of the processes provided herein. In this context, computing system 300 may include, for example, a processor, memory, storage, and I/O devices (e.g., monitor, keyboard, disk drive, Internet connection, etc.). However, computing system 300 may include circuitry or other specialized hardware for carrying out some or all aspects of the processes. In some operational settings, computing system 300 may be configured as a system that includes one or more units, each of which is configured to carry out some aspects of the processes either in software, hardware, or some combination thereof.

FIG. 3 depicts computing system 300 with a number of components that may be used to perform any of the processes described herein. The main system 302 includes a mother—board 304 having an I/O section 306, one or more central processing units (CPU) 308, and a memory section 310, which may have a flash memory card 312 related to it. The I/O section 306 can be connected to a display 314, a keyboard and/or other user input (not shown), a disk storage unit 316, and a media drive unit 318. The media drive unit 318 can read/write a computer-readable medium 320, which can include programs 322 and/or data. Computing system 300 can include a web browser. Moreover, it is noted that computing system 300 can be configured as a middleware server.

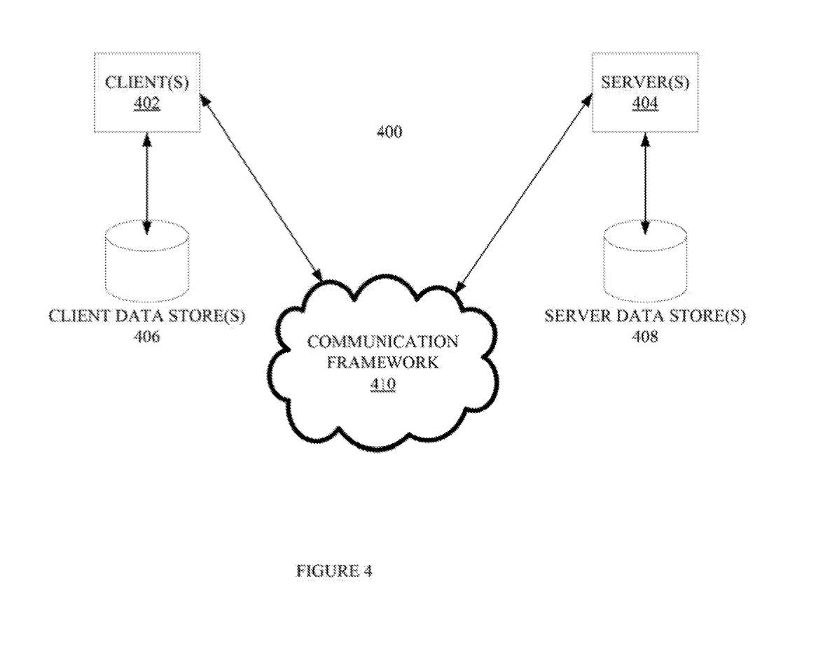

FIG. 4 is a block diagram of a sample computing environment 400 that can be utilized to implement some embodiments. The system 400 further illustrates a system that includes one or more client(s) 402. The client(s) 402 can be hardware and/or software (e.g., threads, processes, computing devices). The system 400 also includes one or more server(s) 404. The server(s) 404 can also be hardware and/or software (e.g., threads, processes, computing devices). One possible communication between a client 402 and a server 404 can be in the form of a data packet adapted to be transmitted between two or more computer processes. The system 400 includes a communication framework 410 that can be employed to facilitate communications between the client(s) 402 and the server(s) 404. The client(s) 402 are connected to one or more client data store(s) 406 that can be employed to store information local to the client(s) 402. Similarly, the server(s) 404 are connected to one or more server data store(s) 408 that can be employed to store information local to the server(s) 404.

In some embodiments, system 400 can be include and/or be utilized by the various systems and/or methods described herein to implement process 100. User login verification can be performed by server 404. Client 402 can be in an application (such as a web browser, augmented reality application, text messaging application, email application, instant messaging application, etc.) operating on a computer such as a personal computer, laptop computer, mobile device (e.g. a smart phone) and/or a tablet computer. In some embodiments, computing environment 400 can be implemented with the server(s) 404 and/or data store(s) 408 implemented in a cloud computing environment.

II. Exemplary Processes and Use Cases

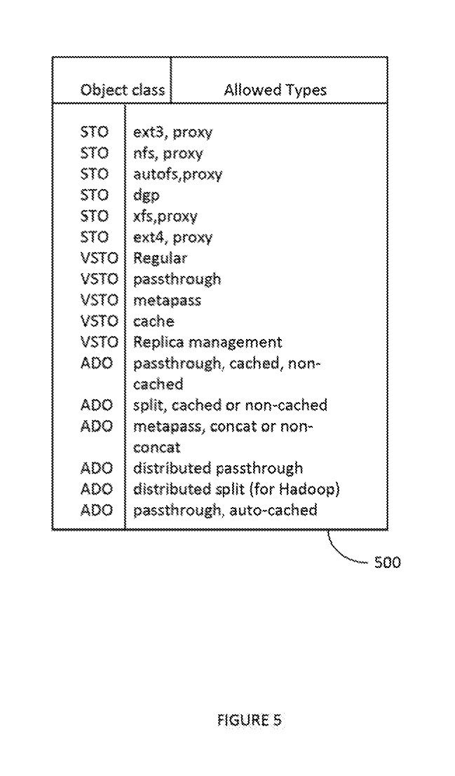

FIG. 5 illustrates a table 500 depicting various data object classes and corresponding allowed data types, according to some embodiments. The general object classes can include, inter alia, STDs, VSTOs, Replica VSTOs, and ADOs. Replica VSTO's can be implemented as a layered VSTO on top of other VSTOs. Replica VSTO's can route requests to an appropriate VSTO. The implementation of these data objects varies depending on the type of the objects and other parameters.

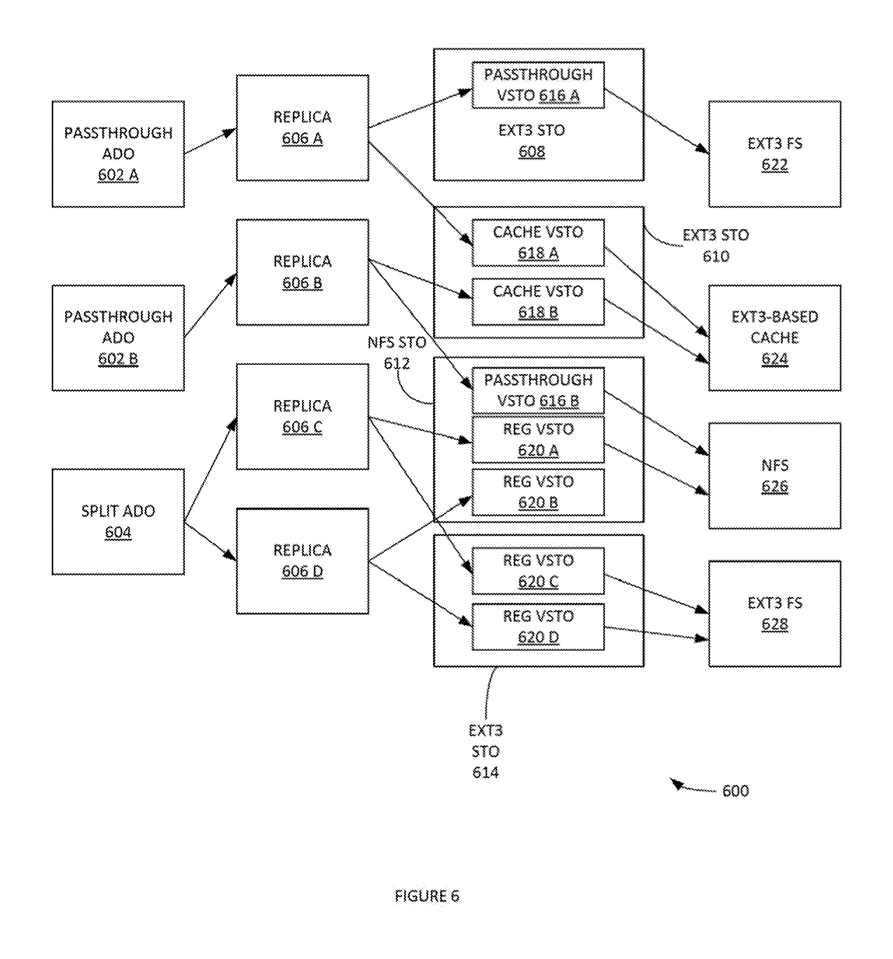

FIG. 6 illustrates an example middleware data management system 600, according to some embodiments. Middleware data management system 600 includes ADOs 602 A-B and 604. ADO's 602 A-B can include passthrough ADO's, one on ext3 (e.g. EXT3-BASED CACHE 624) and one on NFS (NFS 626), both using the same cache. ADO 604 (e.g. a split ADO) can be a two-way replica split ADO. ADO 604 can have files across NFS (e.g. NFS 626) and EXT3-FS (e.g. EXT3 FS 628). FIG. 6 illustrates various other mappings of ADOs 602 A-B and 604 to VSTOs (e.g. passthrough (PT) VSTO 616 A-B, CACHE VSTO 618 A-B, regular (REG) VSTO 620 A-D) to STOs (e.g. EXT3 STO 608, EXT3 STO 610, EXT3 STO 614, NFS STO 612) and the backend file systems (e.g. EXT3 FS 622, EXT3-BASED CACHE 624, NFS 626, EXT3 FS 628). Passthrough data objects can be data objects that reflect the underlying base file system or device's properties. VSTO passthrough functionalities can support directory operations pushed directly to the base file system (FS). ADO and VSTO passthrough functionalities can include intelligence of the overall structure of the data objects to ensure the correctness of the implementation. VSTO cache objects can maintain extra metadata related to mappings of the objects, and other, it is an enhancement of the VSTO regular object implementation. VSTO regular implementation can provide the basic interfaces for VSTO and the virtual data element name spaces. ADO 604 can be implemented on top of a regular VSTO. The ADO 604 can include intelligence of placement of data anywhere in the heterogeneous environment. One can imagine an ADO where it uses one passthrough VSTO, few regular STO, few cache VSTOs. A metaconcat ADO can be an ADO that concatenates multiple passthrough VSTOs to form a concatenated name space for a single ADO. A passthrough auto-cached ADO implemented on top of an autofs STO, creates a passthrough cached ADO for each mount point arrival in the underlying autofs STO. An autofs can be a package that provides support for auto mounting removable media and/or network shares when they are inserted and/or accessed.

Data objects can be implemented with various interface (e.g. integrate into existing file system interfaces as defined by operating systems, proprietary interfaces, etc.). A VSTO (e.g. replica VSTO) can implement an interface defined by the middleware system. The protocol of I/O requests spawned by data objects can follow a set of principles defined by the middleware system as well. A management interface defined by these data objects can enable control of creation, deletion, attachment of data objects, detachment of data objects, etc. according to the object type and the relationship between the objects. These functionalities can be implemented by user-level control services that can invoke input/output control functionalities on the kernel objects.

ADO objects can manage a set of file objects (e.g. an application file object (AFO), directories, special files, regular files with data being stored on the VSTOs in a persistent way, etc.). The distribution of the AFO to the VSTOs can depend on the type of the relevant ADO and/or policies set on the AFO and ADO. AFOs can be iNodes in Linux environment.

A VSTO interface can be implemented by a replica data object and/or various types of VSTO. Use of an STO can be implemented with a handle to the VSTOs created in STO. VSTOs can manage a set of virtual data element objects (VEs). A collection of VE's can belong to a name space. A replica VSTO may not have its own VE name space but may comprise of multiple VSTOs.

The storage data object (STO) can be an umbrella object that serves multiple VSTOs. VSTO(s) in the STO can have different semantics in alignment with the underlying data element. Each of the VSTOs can have multiple VE namespaces. AVE can be the basic object of operation inside a VSTO. An STO can have a one to one mapping to an underlying data element. Occasionally, multiple storage objects per data element can be extant as well. In this case, each STO can be allocated a particular region of the data element. If the underlying data element is a file system and/or an NFS store, then individual directories can become an STO by itself. Thus, there can be multiple independent, non-overlapping STOs corresponding to one data element. STOs can operate on a data element using standard interfaces. An STO can include information on the internals of the data element to exploit some specific optimization capabilities for performance.

An STO can be taken offline or online manually for administrative purposes or a dynamic error on I/O or any other operation on STO can result in the STO being taken offline. When an STO is taken offline, all the VSTOs inside that STO is also taken offline and that results in appropriate notifications to the higher layers so that they can handle these events gracefully. There are provisions to take individual VSTOs offline as well from an administrative point of view if required. The STOs persistent configuration information is stored inside the storage object header. The description of the STO header is given in the above section related to the object persistent control blocks. The STO can be available on top of data elements that are of type ‘file systems’ (e.g. ext3, XFS, NFS, (v3, v4)), on top of raw devices. VSTOs semantics/definitions of the mappings of the VSTO to the internals of data elements can be based on the STO implementation and the VSTO type. For example, in the case of STO on top of a raw device, there can be a VSTO that takes owner ship of that device's I/O related aspects. Whereas in case of a file system there can be multiple VSTOs each of which takes ownership of different directories in the file system and VSTOs should not have any overlap. The STO can provide the following properties when it comes to managing the VSTOs include, inter alia: definitive isolation between the VSTOs so that they can be independently carved out, deleted, without affecting the other VSTOs; provide a VSTO implementation dependent dependencies or interactions, if any, between the VSTOs; space management in terms of size, name space and other; and/or semantics of interaction with the underlying data element.

The storage object (STO) can share the data element with other storage objects or outside entities as well. Thus, either the STO can own the data element exclusively or in a shared manner with other stuff. Appropriate implementation logic to avoid data corruption and security issues should exist in those scenarios.

Virtual data elements can be the basic objects used to store and/or retrieve data in the VSTOs. Each of the virtual data objects can be mapped to an underlying data element in an implementation specific manner. VEs have a size, and many such VEs can be related in an implementation specific manner. For example, a cache VSTO can relate VEs belonging to a one cached file at the ADO level. VEs can be uniquely identified by VE identifiers and/or VE handles. VE handles can be unique inside of each VSTO. VEs can include several attributes related to its data, size, mapping. These attributes can be persisted or not persisted depending on the implementation. A VE namespace can be a collection of VEs that manages the allocation of VE identifiers, deletion, and management. VE namespace belong to a VSTO and can be shared between multiple VSTOs. VE identifier allocation can be based on the implementation as well. A VE identifier can directly map to the identifiers in the underlying data elements and/or can be allocated explicitly and then mapped to the underlying data element object identifiers. The namespace management can be based on the type of VSTO, or the type can be attributed to the namespace itself. For example, in a passthrough namespace management, VEID and/or VE handles can be one to one mapped to the underlying data element objects. The mappers can be used for mapping identifiers from one name space to another name space. Mappers can be persistent if required for fast lookups etc. VE identifiers can be mapped from VE namespace to the underlying data element objects. For example, VE identifiers can be mapped to the files inside data elements and/or any other objects inside data elements.

VSTO can be units of STO's. VSTO can be contained in a STOs. VSTOs can be replicated by layers above (e.g. replica VSTOs). VSTOs can own the VE namespaces. VSTOs can be responsible for managing the life cycle of the VE objects inside the namespace and the VE namespaces belonging to it. VEs can be instantiated on demand based on the operations performed on the VSTO and subsequent operations on the VEs require a VE handle to be passed. VSTO chooses the mapping methodology of the VE namespace to the underlying data element object name space. VSTO can select an appropriate type of mapper to manage the mappings. A VSTO can have a specified size (e.g. defined by blocks). A VSTO can manage the accounting of the blocks used in relation to the STOs and other VSTOs. VSTOs can be instantiated at the time STOs come online. A VSTO can be added into a STOs mounted list of VSTOs. VSTO can be plumbed into the higher layers (e.g. ADO objects) via VSTO object handles. The VSTO object handles can maintain a plumbing specific state and dynamic information. A VSTO can be plumbed into multiple objects at the higher layers depending on the implementation of VSTO. A distributed VSTO can be plumbed locally via a ‘vstobr’ handle and can be plumbed remotely via the remote ‘vstobj’ handle as well. Remote VSTOs implement the interface to interact with the VSTOs on a different node, to operate on the VEs and other objects inside the VSTO. A remote VSTO can use any transport, flexibly NFS, or infiniband-based MPI, or any other. Distributed VSTO objects can allow access of a VSTO from different nodes yet maintain consistency semantics specific to the type of VSTO. A consistency layer at the level of VSTO can enable the higher layers to implement scalable distributed data routing layers.

As described in the table of FIG. 5, different types of VSTOs depending on the name space management, mapping, and other. VSTO types can be regular, passthrough, metapass, and cache types. Regular VSTOs can have one VE namespace, and the VE identifiers can be mapped dynamically to the underlying data element's objects. VE object attributes can store the underlying object identifiers persistently. Regular VSTO can provide the semantics of flat VE objects which contains data. Regular VSTO provides operations for allocation/deallocation of VE identifiers by the top layers, read/write operations on the VE identifiers. Regular VSTOs may not support directory related operations. Regular VSTOs function on top of data elements but map the VE identifiers to the flat objects underneath. In case of passthrough VSTO there is no persistent VE namespace. Instead the VE objects can be in-memory and mapped one to one with the underlying data element objects. VE identifiers can be exactly same as that of the underlying data element objects' identifiers. Passthrough VSTOs support directory operations that can be passthrough operations. Passthrough VSTO passes the operations to the underlying objects (e.g. when VE identifiers are one-to-one) without any remapping operations. Metapass VSTO is similar to passthrough VSTO, except that there is an explicit mapping of VE identifiers to the underlying data element objects. VEID mappings can be maintained such that the data element object identifiers can be persistent. The use of metapass VSTO comes in where the higher-level replication layers want to see a uniform name space for VE identifiers across multiple VSTOs even though the underlying data element object identifiers could change. Cache VSTO implements the caching semantics. Cache VSTO has multiple name spaces—chunk name space, and meta-name spaces. Cache VSTO supports eviction of VEs when running out of space, and has sophisticated algorithms to manage the cache space and accounting. Cache VSTO supports various semantics of ‘writeback’, ‘writethrough’, ‘nowrites’, and/or ‘writealways’ types and cache objects from a corresponding source VSTO. In a typical case source VSTO is a passthrough VSTO and the replica VSTO does the routing of the data between the source and the cache VSTOs. Cache VSTOs uses cache mappers to maintain the mapping of the source objects to cache objects. These mappings can be persistent.

Replica VSTO can be a kind of VSTO used to manage routing/replication policies between multiple and any VSTOs below it. The relationships can be captured in the diagram shown in FIG. 6 (with elements to the left being ‘above’ elements to the right of the figure). Replica manager manages the replica VSTOs. The middleware system can support n-way replica in a generic way. A replica can be a copy of the VSTO. In some embodiments, replicas can be VSTOs. A replica data object can be partial or full replica data object. A partial replica data object may not contain the data necessary for access by higher level objects. A full replica data object can contain the data necessary for access by the higher-level objects. Replica VSTOs can implement error recovery algorithms, synchronization algorithms between the inconsistent VSTOs, all of which can be accomplished while the VSTOs are online.

Application data objects (ADOs) map files and/or directories to the underlying VSTOs. ADO's can integrate into the general file system interface of an operating system. ADOs can provide a meta-file system architecture ‘on top’ of VSTOs which are, in turn, ‘on top’ of existing data elements. Data elements can be file systems (NFS, ext3, and (SCSI, SAN, etc.). The ADO layer can act as a “Data Router” to route the data to different VSTOs. The ADO layer can provide the infrastructure of dynamically managing data placement and scaling based on applications' SLA/SLO requirements. The ADO layer can utilize mappers (e.g. regular mappers, passthrough mappers and/or ‘fb mappers’) to map ADO level objects to lower level objects. Different types of ADOs can include, inter glia: passthrough ADO (E.g. an ADO in conjunction with the replica layer routes the data to data elements and the cache devices for increased performance; a metapass ADO (e.g. an ADO in conjunction with replica layer routes the data for replication, or caching); Split/Scalable ADO (e.g. an ADO that scales across multiple data elements by splitting files, replicating across the VSTOs that are on top of the data elements); a distributed ADOs (e.g. a distributed ADOs that can provide the abstraction of a single ADO across multiple nodes and it can be of type passthrough, split/scalable); and/or concatenation ADOs (e.g. an ADO that allow concatenation of a set of VSTOs in passthrough mode).

III. Mapping Overview

In various embodiments, mappers may be objects that support persistent mapping of one namespace identification to another namespace identification, which is sometimes described as the concept of resolution. A namespace might apply to a particular Virtual Storage Object (VSTO) or to a set of VSTO's. Mappers may include the logic for and perform transformation, maintenance, and persistence. New mappers can be added dynamically without changing the fundamentals of existing code around Application Data Objects (ADO) and other objects. Various types of mappers may include: regular mappers, file-based mappers, pass through mappers, and cache mappers.

Mappers may identify relationships between an object (e.g., a data object) and one or more VSTOs. Mappers may directly map identifications, and some mappers may map one identification to multiple identifications based on regions of data. Some mappers are persistent, and others are not.

Within a middleware architecture, the primary interface for mappers may include: readmap, writemap, resolve, deletemap, etc.

IV. Types of Mappers

A. Regular Mappers

Regular mappers map ADO level objects to one or more Virtual Element (VE) objects inside one or more VSTOs. Regular mappers may typically be used for split ADOs, which may be mapped to multiple VSTOs in an infinitely scalable manner.

The VSTOs can correspond to different data elements having various characteristics in terms of performance, reliability, and efficiency. At the ADO level, Application File Objects (AFO) can maintain persistent information corresponding to which offset maps to which Virtual Element Identification (VEID). Regular mappers contain an algorithm based on policies defined for the AFOs at the directory level or file level. Typically, the next level of VSTOs are replica VSTOs from the ADO layer.

Allocation of a new mapping to an AFO involves: a) selection of the appropriate VSTO; b) allocating the VEID from that VSTO. The policy corresponding to the file is maintained in the AFO. Examples of various policies may include: place in faster storage, or place in more reliable storage with defined reliability. Examples of defined reliability may be n-way replication, parity-based protection, disaster recovery protection, etc. The VSTO object may inherit the reliability/performance characteristic from the data element object, which can thus make the reliability/performance characteristic available at the mapper layer. These properties may be defined at the time a Storage Object (STO) is created, or they may be auto-learned during operation of the system.

Algorithms may help stripe files for parity protection based on space availability and the LOAD on one or more VSTOs. For example, all *.o files could be placed on a memory based VSTO, while *.jpg files could be placed on low cost IDE based VSTOs. Mapping information for regular mappers may be co-located within the AFO object itself.

B. File Based Mappers

File based mappers (FB Mappers) work for AFOs that might work less well with regular mappers, such as files that are up to a petabyte or larger, with VEs that are potentially one Gigabyte or larger (one Gigabyte being an example limit here, it can be any configurable limit)

The mapping for a file-based mapper may be persistently stored on a particular VSTO, which can use faster storage to help accelerate access to a large file and may operate separately from an AFO. File based mappers may operate differently than regular mappers with respect to allocation algorithms and choices of VSTOs.

C. Passthrough Mappers

Passthrough mappers may be 1-1, and may have limited amounts of logic in terms of placement. Passthrough mappers may provide flexibility for accommodating VSTOs that correspond to data elements that are used in a passthrough mode.

D. Cache Mappers

Cache mappers dynamically map source VEIDs to VEIDs of cache VSTOs for faster access. The source VEIDs can be added or removed from cache VSTOs at any time. Multiple race conditions may be handled by a cache mapper algorithm. Synchronization with VEID accesses from source and cache and top-level ADO mappings to them may be complex.

The cache mapper may be accomplished using a persistent file that reverse maps the source VEIDs to cache VEIDs, and that assigns the source VEIDs as owners for the cache VEIDs. The synchronizing happens on the source object's lock. The lock on the cache object is obtained once the cache object is looked up.

A readmap method of applying the cache mapper may perform negative lookups efficiently and may also plumbs the cache handle to the top layer ADO as an optimization to avoid accessing or viewing the persistent information each time.

A cache mapper may implement (e.g., create and use) chunks of data to help map source VEIDs to cache VSTOs. Each chunk has a VEID that corresponds to a source side VEID, which can be called as the owner of the chunk VEID. The first chunk representing the source side VEID is called a metachunk, and it contains both data as well as meta information that corresponds to all the chunks of the source VE object. Each chunk can be of varying sizes, depending on the amount of data cached. The maximum chunk size is configurable, at a VSTO level, and the size applies on all the VE objects in the VSTO.

The chunk VE objects may be allocated in the mapper on-demand. In this way, a source VE object can be sparsely mapped to multiple cache VE objects. The cache mapper also maintains the bitmaps of which blocks of the source VE objects have been cached in the cache VE object. All logs associated with cache VE objects are maintained by the cache mapper, and crash/recovery management may be performed using cache consistency algorithms.

V. Exemplary Operations

A. Passthrough Mappers and Cache Mappers

A passthrough ADO may sit directly on top of the existing data directories or mounted file systems. When combined with a cache device, it can increase application performance.

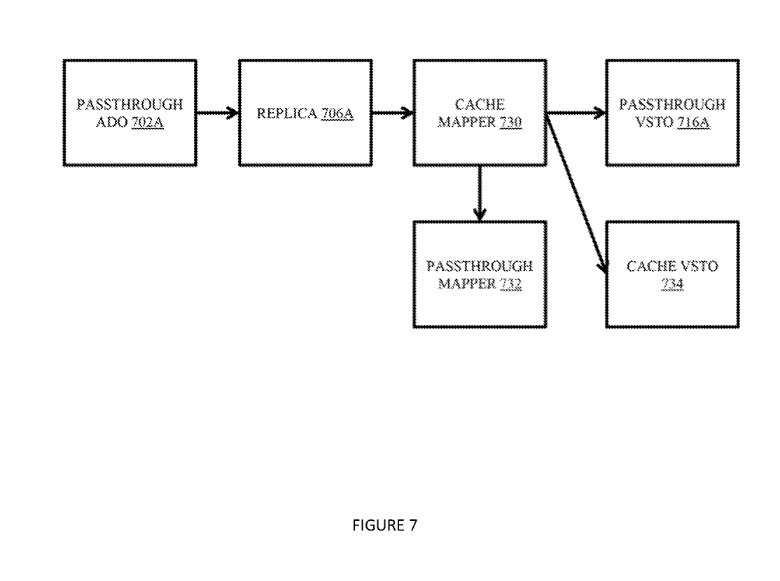

In FIG. 7, an exemplary system includes a passthrough ADO 702A, a replica 706A, a cache mapper 730, a passthrough mapper 732, a passthrough VSTO 716A, and a cache VSTO 734. The passthrough VSTO 716A is from a source device storage object. The cache VSTO 734 is from a cache device storage object. Data is cached after a first read, and data is fetched from the cache from second and subsequent reads. Performance can thus be increased.

In an example, a read I/O operation may be performed on a 100 MB file. Assume the I/O size is 64 KB and the offset from where the read should happen is 10 MB. In this example, each first level subchunk is 2 MB, although they may be of varying sizes in other embodiments. Given a 10 MB offset, the first level subchunk for the I/O is the 6th first level subchunk.

The I/O starts from the application layer, traverses down to the replica layer, and from there to one of the passthrough VSTO 716A and the cache VSTO 734. Given that one of the VSTOs is associated with the source device and the other VSTO is associated with the cache device, the system needs to determine whether the cache VSTO contains the information.

Four possible scenarios are considered: 1) this is the first time a read I/O is occurring for the given file; 2) some I/O has already happened on the given file, and the metachunk has been created, but the appropriate first level subchunk has not been created; 3) the first level subchunk (e.g., the appropriate 2 MB subchunk) is in cache, but the requested second level subchunk is not in cache (e.g., the requested 64 KB of blocks are not cached); 4) the first level subchunk and the desired second level subchunk are in cache.

1) This is the first time a read I/O is occurring for the given file. The system learns that the metachunk has not been created. The passthrough mapper 732 is used to store the iNode number of the main file and to associate it with the metachunk's VEID. First and second level subchunks are not necessarily created.

2) Some I/O has already happened on the given file, and the metachunk has been created, but the appropriate first level subchunk has not been created. The cache mapper 730 gets the metachunk and finds out if the 6th first level subchunk has been created. Because it has not been created, the system retrieves the data from the passthrough VSTO 716A and creates the first level subchunk.

3) The first level subchunk (e.g., the appropriate 2 MB subchunk) is in cache, but the requested second level subchunk is not in cache (e.g., the requested 64 KB of blocks are not cached). The cache mapper 730 gets the metachunk and finds out if the 6th first level subchunk has been created. The cache mapper then refers to the VEID of the first level subchunk and obtains the block bitmap for the first level subchunk. The block bitmap may include 512 bits, each corresponding to a 4 KB page.

The cache mapper 730 then checks the block bitmap to determine whether the requested second level subchunk is within the first level subchunk. Because it has not been created, the system retrieves the data from the passthrough VSTO 716A and creates the second level subchunk. The cache mapper 730 may then update the block bitmap of the corresponding first level subchunk (e.g., the 6th first level subchunk), for future I/Os to be served from the cache.

4) The first level subchunk and the desired second level subchunk are in cache. The cache mapper 730 gets the metachunk and finds out that the first and second level subchunks are present. The system can then retrieve the information from the cache VSTO 734.

B. Regular Mappers and File Based Mappers

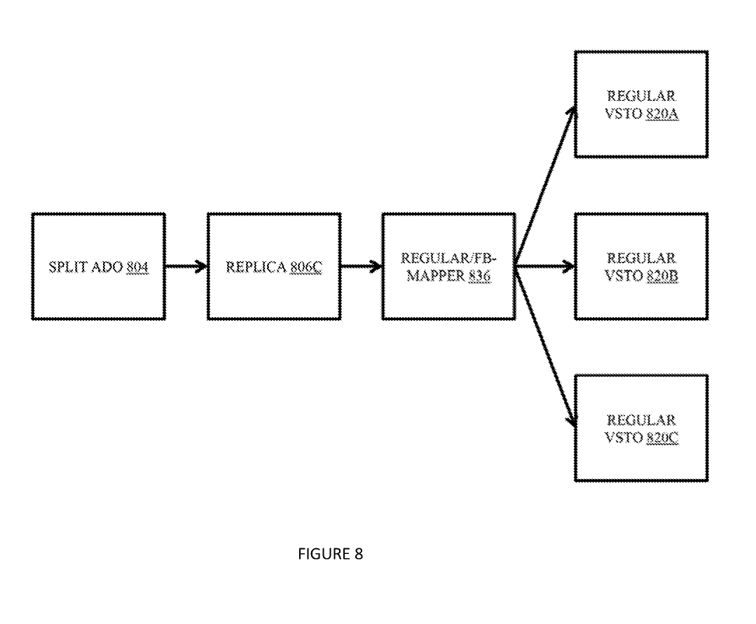

FIG. 8 includes a split ADO 804, a replica 806C, a regular/FB mapper 836, a regular VSTO 820A, a regular VSTO 8208, and a regular VSTO 820C.

A split ADO 804 may be used with multiple VSTOs (e.g., regular VSTOs 820A, 820B, 820C, etc.) associated with multiple devices (e.g., STOs) that may be local and/or remote. The split ADO 804 may combine the capacity available from all the VSTOs and present a single namespace for the user to use. When files are stored in the split ADO 804, they are actually being split across different VSTOs having different devices.

In an example, if a 1 GB file is copied to a split ADO 804 that is formed from four VSTOs, then the 1 GB file may be split into 64 MB chunks. For a 1 GB file, this may mean that 16 chunks are used to make up the 1 GB file, and each chunk may be stored in one of the four VSTOs in round robin fashion. In other words, the first VSTO will have chunks 1, 5, 9, and 13, and the second VSTO will have chunks 2, 6, 10, and 14, and so forth.

In some embodiments, the split ADO 804 may also contain an equal number of cache VSTOs where the user wants capacity as well as performance.

The difference between when the regular/FB mapper 836 acts as a regular mapper or the file-based mapper involves the way they operate and the conditions when each is invoked in some other embodiments, a separate regular mapper and a separate file-based mapper are used.

When a file is first created, the regular mapper is assigned as the default mapper. If the file grows beyond a size limit (e.g., 512 MB, which may be a configurable value), then the default mapper (e.g., the regular/FB mapper 836) for the file may be dynamically and automatically changed from the regular mapper to the file-based mapper. In some embodiments, the default mapper may be changed back to the regular mapper from the file-based mapper for files that shrink below the threshold.

The information for the regular mapper may be inside the application file object itself. In contrast, the file-based mapper may use a special persistent file for each iNode to maintain information. An iNode can be a data structure in a Unix-style file system that describes a filesystem object such as a file or a directory. Each iNodes stores the attributes and disk block location(s) of the object's data.

V. Exemplary Operations

Writeback

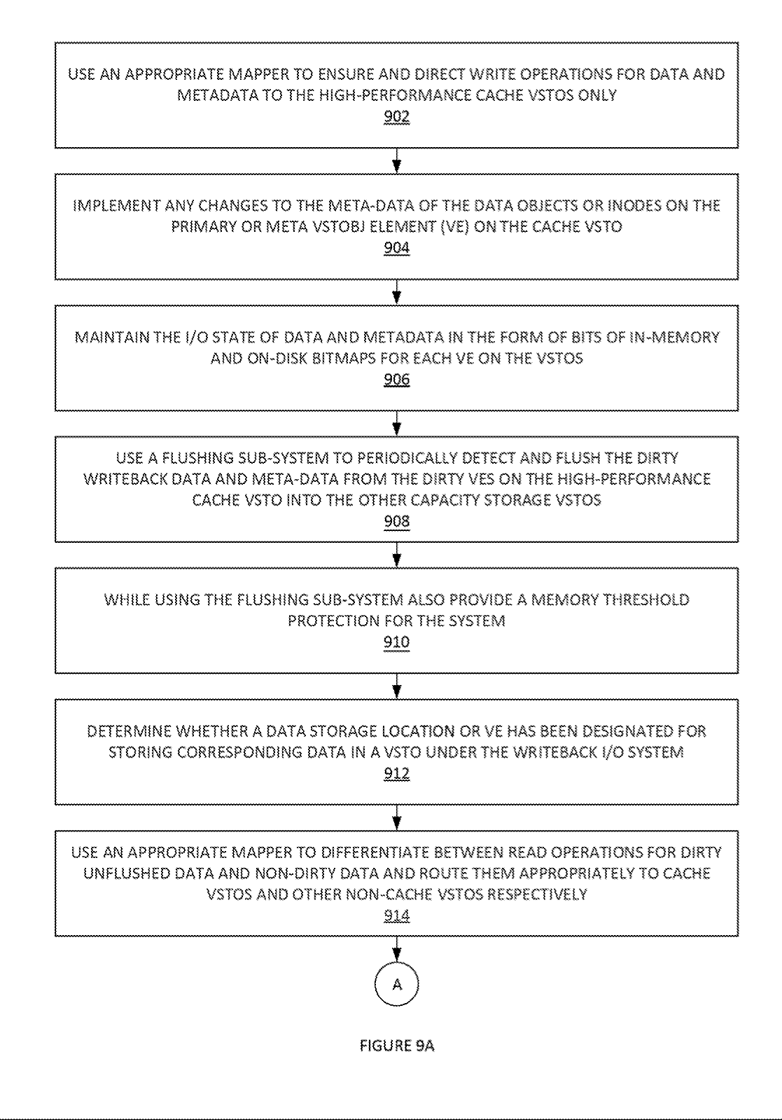

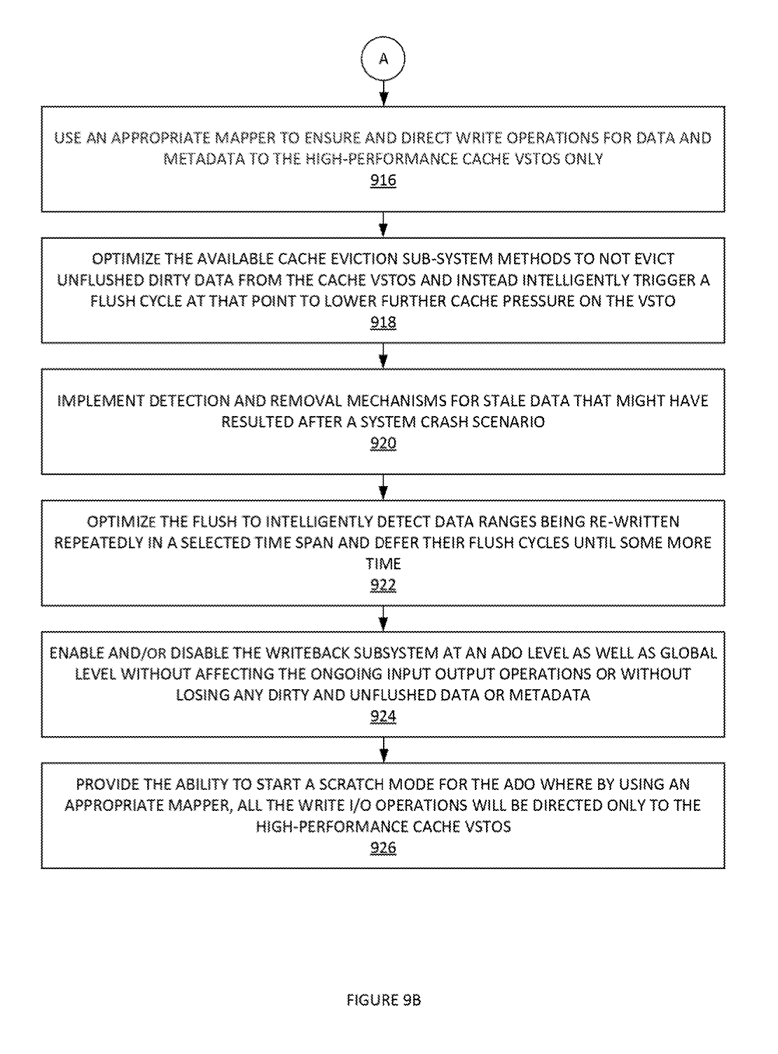

FIGS. 9 A-B illustrate an example process 900 of writeback based input output system and methods of an accelerated application-oriented middleware layer, according to some embodiments. In step 902, process 900 uses an appropriate mapper to ensure and direct write operations for data and metadata to the high-performance Cache VSTOs only and thereby reduce the write latencies considerably.

In step 904, along with the data, any changes done to the meta-data of the data objects or iNodes, can also be done on the Primary or Meta Vstobj Element (VE) on the Cache VSTO to ensure faster completion of the operations, also called as Attribute writeback.

In step 906, process 900 can maintain the I/O state of data and metadata in the form of bits of in-memory and on-disk bitmaps, for each VE on the VSTOs, where the data is segregated into a sequence of individual units of 4K bytes each. A similar state can also be maintained at each VE level as well. In this way, a full-fledged file level writeback system can be implemented.

In step 908, process 900 can use of a flushing sub-system to periodically detect and flush the dirty writeback data and meta-data from the dirty VEs on the high-performance Cache VSTO into the other Capacity Storage VSTOs. The flushing methods will use appropriate locking constructs at multiple levels to make sure that the ongoing data access and modification operations in parallel, do not result in the incorporation of any kind of stale or outdated data. The flushing methods will also ensure that the I/Os spawned to read from Cache VSTOs and write to non-Cache VSTOs will always be formed with the maximum possible number of sequential data ranges available instead of a fixed data set size. This will lead to the spawn of a lesser number of I/Os and thereby reduce the total memory and CPU overheads by some extent.

In step 910, process 900 can, while using the flushing sub-system, also provide a memory threshold protection for the system. Within which the flushing sub-system, step 910 can operate and pause once it hits the threshold. A paused flushing sub-system can resume flushing from the same data range once the next flushing cycle starts.

In step 912, for an input output operation, process 900 can determine whether a data storage location or VE has been designated for storing corresponding data in a VSTO under the writeback I/O system. Process 900 can also determine whether all or some of the data in the requested I/O range are already marked as dirty.

In step 914, process 900 use an appropriate mapper to differentiate between Read operations for dirty unflushed data and Non-Dirty data and route them appropriately to Cache VSTOs and other Non-Cache VSTOs respectively. For Read operations that include a combination of both Dirty and Non-Dirty data ranges, step 914 can intelligently split the I/O into multiple Sub I/Os, each comprising of sequential dirty or non-dirty data ranges and eventually route them to Cache VSTO or non-Cache VSTO as applicable and decided by the mapper used.

In step 916, process 900 can use of an appropriate mapper to perform the meta-data operations (e.g. truncate, attribute writes, etc.) on the cache VSTO only and acknowledge the operation completion once it's done and marked dirty in the cache VSTO.

In step 918, process 900 can optimize the available cache eviction sub-system methods to not evict unflushed dirty data from the Cache VSTOs and instead intelligently trigger a Flush cycle at that point to lower further cache pressure on the VSTO.

In step 920, process 900 can implement detection and removal mechanisms for Stale data that might have resulted after a system crash scenario. The sub-system can maintain the I/O states persistently for ongoing Write operations and clears them only when the I/O completes. These I/O states, along with other on-disk and in-memory bitmaps, can be then used by the methods to detect the presence of stale data or partially written data on the cache VSTOs.

In step 922, process 900 can optimize the flush to intelligently detect data ranges being re-written repeatedly in a selected time span and defer their flush cycles until some more time. This can reduce the CPU cycles that would have been consumed because of repeated flush-write cycles on the Non-cache VSTOs.

In step 924, process 900 can enable and/or disable the writeback subsystem at an ADO level as well as global level without affecting the ongoing input output operations or without losing any dirty and unflushed data or metadata. Process 900 can use of proper locking constructs at various implementation layers of the all the related sub-systems. In step 926, process 900 can provide the ability to start a scratch mode for the ADO where by using an appropriate mapper, all the Write I/O operations will be directed only to the high-performance Cache VSTOs. Process 900 can ensure that the accumulated dirty data on the VSTOs will never be flushed to the Capacity layer VSTOs. All new writes and re-rewrites can go to the Cache VSTOs only. In this mode the directory and full directory caching is implemented (e.g. as ‘data only’ scratch model and not the directories, etc.).

Process 900 can provide ability to the user to either stop the scratch mode and discard the accumulated dirty data or finalize the scratch mode and flush the dirty data to other capacity layer VSTOs. It is noted that once scratch mode is finalized, the recent data may not be discarded.

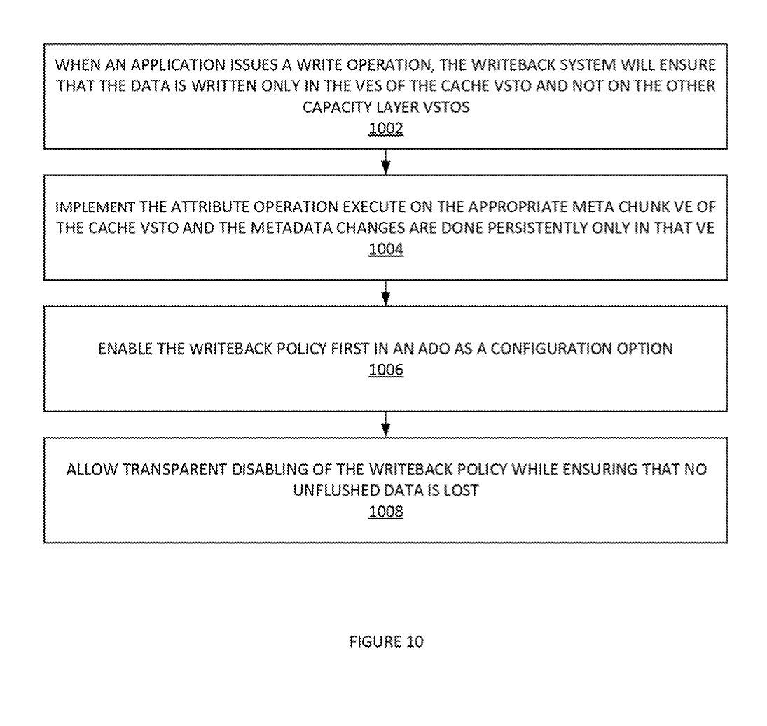

FIG. 10 illustrates an example process 1000 for writeback policy overview, according to some embodiments.

Process 1000 can provide applications with faster I/O operations and lower latencies by performing the write oriented operations on high performance disks only. The high-performance disks may include, inter alia: Solid State Disks (SSDs), nVME drives and other forms of high speed devices. These devices can be available in example systems in the form of Storage Objects (STOs) and Virtual Storage Objects (VSTOs). The writeback policy will apply to both data write operations as well as attribute write operations.

In step 1002, when an application issues a write operation, the writeback system will ensure that the data is written only in the VEs of the cache VSTOs and not on the other capacity layer VSTOs. The operation completion can then be acknowledged to the application. As the cache VSTOs are high performance devices, so the write latency will be very less as compared to traditional spindle-oriented disks or network shares. This data will be written to multiple cache VSTOs automatically, if the system is configured for Replication mode.

In step 1004, when an attribute change operation is issued, the writeback system implements the attribute operation to be executed on the appropriate Meta Chunk VE of the cache VSTOs and the metadata changes are done persistently only in that VE and not on the capacity layer VSTOs file. This can enable very fast operation completion because of the high-speed cache VSTOs.

The writeback system's main objective can include reducing the numerous writes on the capacity layer VSTOs, which are generally slower in speed. To achieve this objective, it ensures all write operations are done in the cache VSTOs only and later after some time period, all the accumulated dirty data, present only on the cache VSTOs, are flushed back to the capacity layer VSTOs. Accordingly, in a specified time interval, instead of performing numerous slow writes and re-writes on the capacity layer VSTOs from slow devices or network file systems like NFS3 or NFS4 or CIFS or Amazon S3 etc., the writeback system can perform one single write for each 4K unit of data on the capacity layer VSTOs, irrespective of the number of times each 4k unit was written or re-written. This will save un-necessary writes and re-writes which would have happened on the capacity layer VSTOs as well in the absence of the writeback system.

In step 1006, process 1000 can have the writeback policy to be first enabled in an ADO as a configuration option. This writeback policy can be defined as a Flag value in the ADO's in-memory as well as persistent on disk metadata structures. This value of the flag can then be verified by other sub-systems and method to ascertain if Writeback policy is enabled or not.

In step 1008, the writeback system can also allow transparent disabling of the policy while ensuring that no unflushed data is lost.

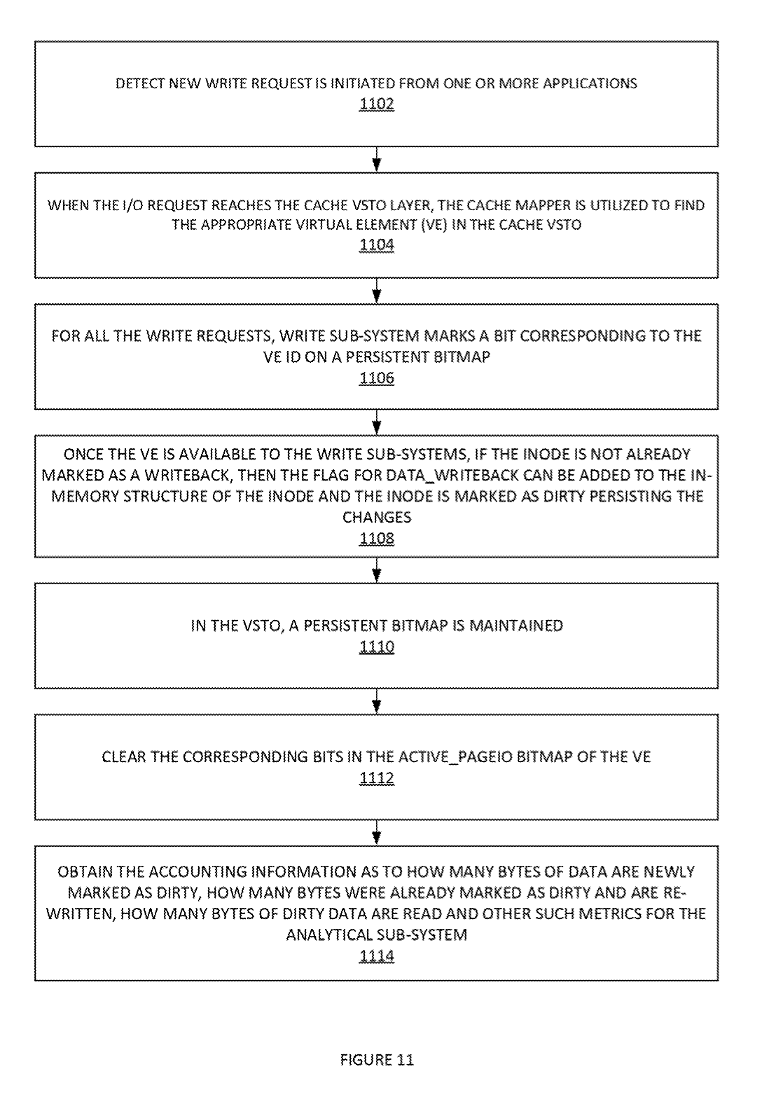

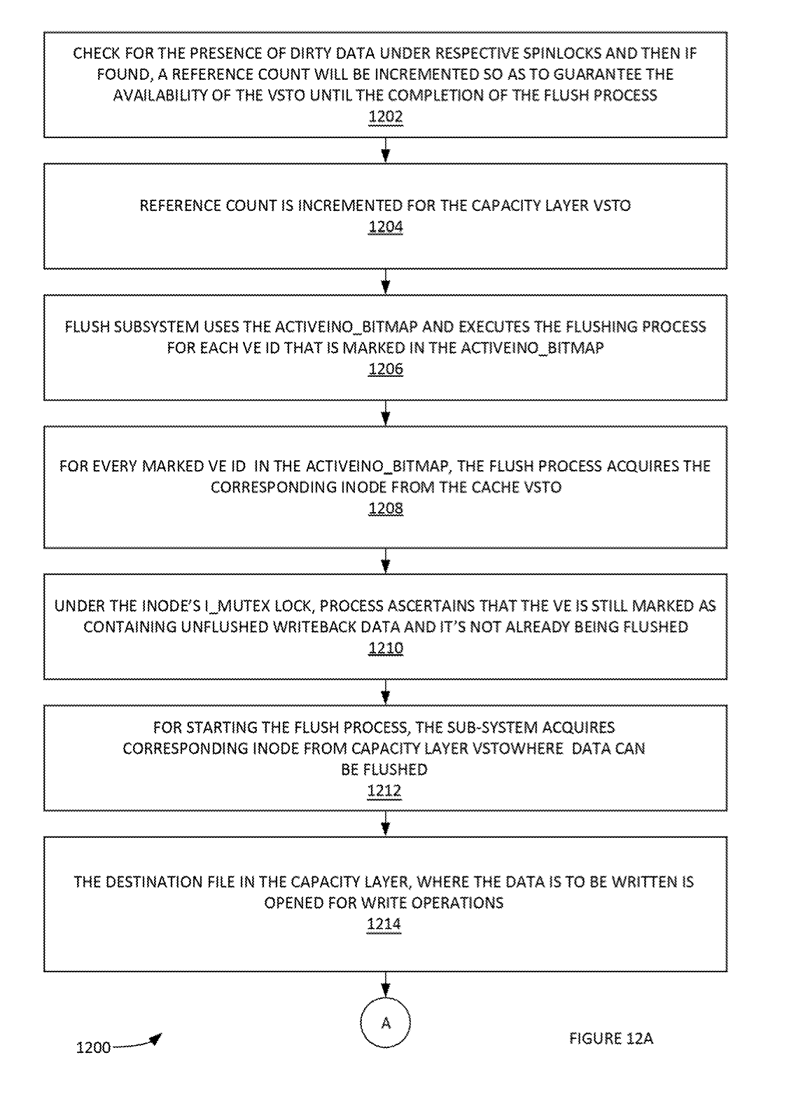

FIG. 11 illustrates an example process 1100 for writeback policy for i/o operations, according to some embodiments. In step 1102, when a new write request is initiated from one or more applications, it reaches a replica layer. Step 1102 can take several possible actions based on various factors. If the ADO is detected as a Writeback ADO, then the I/O is further sent for completion only to Cache VSTOs. Other non-Cache VSTOs are ignored for the write I/O. This write request is marked as a Writeback I/O Request by adding proper flag value in the in-memory structure of I/O request. If no Cache VSTOs are available, then the I/O will be marked as failed.

In step 1104, when the I/O request reaches the Cache VSTO layer, the cache mapper is utilized to find the appropriate Virtual Element (VE) in the Cache VSTOs. Here, there are two (2) cases that may be implemented. In one case, if the Mapper is able to resolve and finds the I/O's corresponding VE in the cache VSTO, where the write would happen. In this case it returns the appropriate VE's iNode. If the mapper is unable to resolve and find the VE in the cache VSTO, which would be the common case when the first write I/O comes for the VE and the part of the file is not yet cached, then the mapper can proceed and create the VE. The mapper can then retry resolving and finding the VE again, and it may obtain the VE this time. Accordingly, it can return the appropriate VE's iNode. If due to any reason, the creation of the VE fails or the mapper is unable to find the VE, then the I/O can be marked as failed in this case.

This process of write operation can be carried out in all Cache VSTOs forming the ADO, for maintaining replication and high-availability of data.

In step 1106, for all the write requests, the write sub-system marks a bit corresponding to the VE id on a persistent bitmap called “activeino_bitmap”. This can be done to determine the VE IDs where a write operation was recently implemented. This bitmap can be stored at per VSTO level and each bit corresponds to a VE on the VSTO. The bits can be cleared by a cleaner sub-system in the form of a kernel thread, which executes periodically and clears the bit for the VEs which did not see a write operation in certain configured time interval.

For example, VEs may not have seen any write operations for a specified period of time (e.g. in the last ten seconds (10 secs) or fifteen seconds (15 secs). For modifying a bit, a lock can be acquired for that bit. This lock can also be maintained in the form of in-memory bitmap where candidates compete to acquire it and only one of them gets the lock, while others wait on it until the first candidate releases the lock after modifying the bit. This can prevent parallel modifications for the same VE and allows parallel modifications for different VEs. This process can be implemented within the ve_mutex mutex lock of the VE

In step 1108, once the VE is available to the write sub-systems, if the iNode is not already marked as a Writeback, then the flag for DATA_WRITEBACK can be added to the in-memory structure of the iNode and the iNode is marked as dirty to later persist the changes. This can be implemented under the mutex lock of the iNode. The ADO's may not already be marked as containing DIRTY_WRITEBACK_DATA, then the same is done here within spin locks. This is the case of the first write operation only.

After that for all other I/Os, the ADO is already marked as DIRTY_WRITEBACK_DATA. The VSTO is also informed that there is a new iNode which contains dirty writeback data, by incrementing a dirty iNode count in the inmemory and on disk structures of the cache VSTO. This can also be implemented under the same spin lock. The above steps are only done, if the VE is not already marked as DATA_WRITEBACK. The write operation may be for the first chunk VE or the meta chunk itself or any of the child chunk VEs as well. Accordingly, if it's for any child chunk VE, then its meta chunk VE can be retrieved. It can also be informed that one of its child chunk is marked as writeback dirty and can be flushed in future. This can be done by incrementing the nflush_chunks count of the Meta VE when a non-meta VE is marked as DATA_WRITEBACK. The meta VEs fchunk_mutex can be held while the increment is performed. This can provide a clear image of the child VEs of a Meta VE which are holding dirty writeback data at any point of time.

In step 1110, in the VSTO, a persistent Bitmap is maintained in a file. This can be called as “active_pageio” bitmap for all VEs. This can contain one (1) bit of information for every corresponding page of every VE or four kilo-byte (4KB) units of data of the VE. For example, if VE size is 2MB, then each VE would require five hundred and twelve (512) bits of bitmap or a bitmap of sixty-four (64) bytes. Accordingly, the active_pageio file can contain numerous bitmaps, each of size sixty-four (64) bytes and corresponding to each VE, ordered in terms of VE IDs.

For example, sixty-four (64) bytes for VE ID 4, then sixty-four (64) bytes for VE ID 5, sixty-four (64) bytes for VE ID 6 and so on. Before the write operation starts, process 1100 can mark the corresponding bits in the corresponding VE's bitmap to indicate that the I/O is going to start for some pages of the VE. These bits can be updated synchronously on the disk. These bits will be cleared once the I/O completes successfully.

In case a system crash happens, then this bitmap will be checked for marked bits and we will have an indication that the write operations started for those bits that have not completed. Accordingly, the corresponding data in the VE may be stale or incomplete or partially written. Step 1110 can be done under mutex lock of the VE's iNode to protect the bitmap from parallel updated from the same iNode and simultaneously allowing the update of other VE's bitmaps in parallel.

In step 1112, once the write operation completes, process 1110 can then clear the corresponding bits in the active_pageio bitmap of the VE. This can be done under the same mutex lock which was used during setting of the bits. Apart from that, as the write operation has completed, process 1100 can have some unflushed data that needs to be marked as dirty. So, an in-memory bitmap is maintained, called as “wback_bitmap”, in each VE, which is large enough to hold all the bits corresponding to all four kilobit (4 KB) units of data of the VE (e.g. for a VE of size two megabits (2MB), process 1100 can use five hundred and twelve (512) bits or sixty-four (64) bytes of bitmap in the VE). Accordingly, for all successfully completed write operations, the corresponding bits are set in the wback_bitmap and the VE's iNode is marked as dirty to persist the bitmap on disk through a write_inode.

In step 1114, during this process, process 1100 obtains the accounting information as to how many bytes of data are newly marked as dirty, how many bytes were already marked as dirty and are re-written, how many bytes of dirty data are read and other such metrics for the Analytical sub-system. The appropriate data structures can be updated with these metrics under appropriate locking mechanism.

An example process for writeback for non-I/O metadata operations is now discussed. In case of a truncate operation for the writeback ADO, such as a supporting Attribute Writeback, the operation can be sent to the cache VSTOs and not the other capacity layer VSTOs. For this truncate operation, the minimum truncate offset seen will also be recorded in the in-memory data structure of the Meta VE chunk of the current VE being truncated. It will be called as “mintrunc_offset”. This default value will be set to the VE size when the VE is created.

This value can be used to handle attribute writeback scenarios involving truncates and reads coming thereafter. The cache mapper can refer this min_trunc_offset value while resolving VEs for Read operations. If the read operation is for offsets beyond the min_trunc_offset, then there won't be data, as a truncate operation is already issued before the read. If the read operation is on the 4K page on which truncate was issued, then the part of the page beyond the truncate size will be all zero, as it is supposed to have been truncated. Accordingly, if the current truncate new size is less than the recorded min_trunc_offset value, then the value of min_trunc_offset can be updated with the new size value.

In case of setattr family of operations modifying either the size of the file or mtime or ctime of the file, in a writeback ADO supporting Attribute Writeback, the operation will be sent only to the cache VSTOs and not the other capacity layer VSTOs. When the I/O request reaches the Cache VSTO layer, the cache mapper is utilized to find the appropriate Virtual Element (VE) in the Cache VSTO, where this I/O should happen.

Here, there are two cases that may happen. First one, if the Mapper is able to resolve and finds the file's corresponding Meta VE in the cache VSTO, where the operation would happen. In this case it returns the appropriate Meta VE's iNode. If the mapper is unable to resolve and find the VE in the cache VSTO, which would be the common case when the first operation comes for the file and the file is not yet cached, then the mapper can proceed and create the VE right there. The Mapper can then retry resolving and finding the VE again, and it would obtain the VE this time. As such, the Mapper can return the appropriate VE's iNode. If due to any reason, the Creation of the VE fails or the Mapper is unable to find the VE, then the operation can be marked as failed in this case.

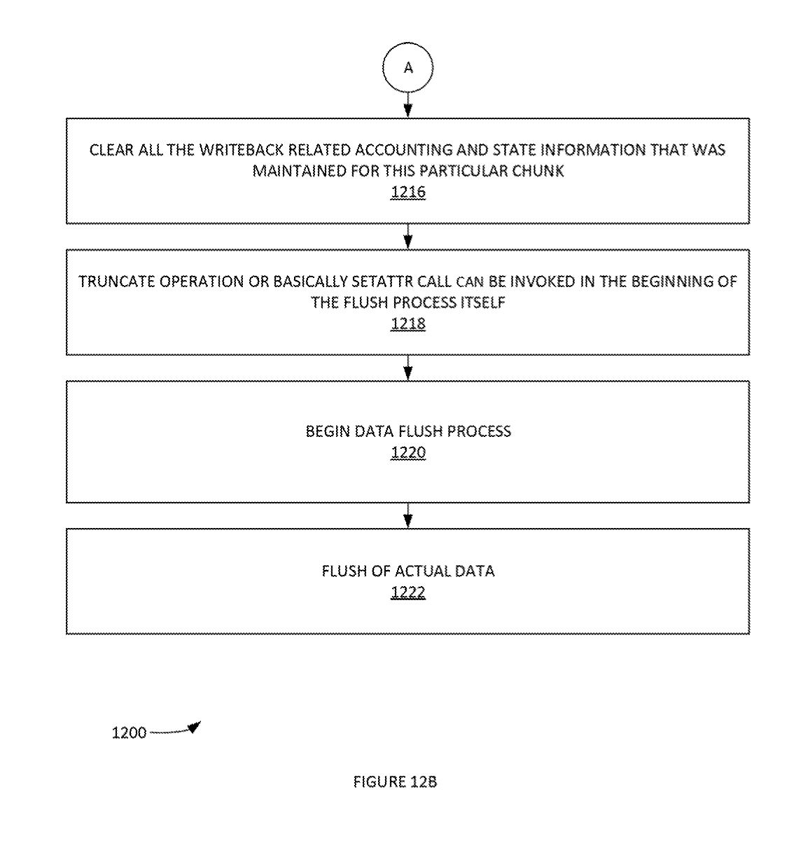

FIGS. 12 A-B illustrates an example process for implementing a writeback flush sub-system, according to some embodiments. The unflushed ‘dirty’ writeback data accumulated over a period of time can be flushed to the capacity layer VSTOs periodically. For this, we will have a flushing sub-system in the form of an infinitely running kernel thread which can periodically wake up (e.g. every thirty (30) seconds, sixty (60) seconds, another configured time interval configured, etc.) and then start the flush process for all the Cache VSTOs marked to contain dirty data. For Cache VSTOs under a common replication group, only one will be picked for flushing, as all of them contain the same dirty data and metadata.

In step 1202, before the flush methods execute for a particular VSTO, they can be checked for the presence of dirty data under respective spinlocks and then if found, a reference count will be incremented so as to guarantee the availability of the VSTO until the completion of the flush process.

As the flush process involves reading the dirty data from the high-performance cache VSTO and writing to the capacity layer VSTOs, a reference count is incremented for the capacity layer VSTO, in step 1204. This can provide the availability of the destination as well until the completion of the flush process. Before the flush starts, the Cache VSTO is marked as “FLUSH_IN_PROGRESS” to indicate others that the cache VSTO is currently under the flushing process and also to prevent scenarios of multiple flush requests getting triggered at the same time for the same cache VSTOs, either automatically or manually.

In step 1206, to find out the VEs (which contain dirty unflushed data), the flush subsystem uses the activeino_bitmap and executes the flushing process for each VE id that is marked in the activeino_bitmap.

The cache VSTO also contains an in-memory and persistent variable which stores the last VE ID that was flushed by the flush thread. This can be called as flush_break_id. In general, this can be zero (0). But, if due to certain circumstances, the flush process is stopped mid-way, then the VE ID information will be captured in this variable of the VSTO. The next time the flush process resumes, it can check this value and continue flushing from the same VE. This can be used to ensure that the remaining VEs are flushed at least once before starting from beginning.

In step 1208, for every marked VE ID in the activeino_bitmap, the flush process acquires the corresponding iNode from the Cache VSTO.

In step 1210, under the iNode's i_mutex lock, it ascertains that the VE is still marked as containing unflushed writeback data and it's not already being flushed. The flush system also intelligently reduces net writes on the capacity layer VSTOs for VEs which are re-written frequently or in other words, heavy write intensive scenarios. In such cases, a VE is eligible to be flushed only if its last write was before a certain configurable time period like say 15 secs back or 60 secs back. This highly optimizes the flushing process and prevents un-necessary re-writes on the capacity layer VSTOs as a result of repeated flushing of the same VEs.

In step 1212, for starting the flush process, the sub-system acquires the corresponding iNode from the capacity layer VSTO, called as “destination iNode” or “destination file's iNode”, where the data can be flushed. During the flush, the capacity layer file will be locked for write I/Os in the data range corresponding to the cache VE's offset range, via a shared Range lock. And cache VE will be fully locked for newer write I/Os or other operations at the same time, via an exclusive lock. This locking mechanism is done by acquiring appropriate RANGE_LOCKS and EXCLUSIVE_FULL_LOCKS on the capacity layer iNode and cache layer iNode respectively. Range locks and exclusive full locks collectively enables continued high performance I/O to happen in presence of flush as the lock is fine grained to have parallel I/Os happen on the same veld between multiple application processes and the flush process.

In 1214, the destination file in the capacity layer, where the data is to be written is opened for write operations.

For capacity layers involving NFS STOs and VSTOs, the flush of data for a particular file can be implemented under the credentials of the owner of the file. In this way, appropriate kernel layer credentials can be prepared and set in the current context before the open of the file is done. This can be used to ensure that the backend NFS servers allow the write operations initiated from the flush sub-system to happen on the file.

In case the destination file itself is unlinked or renamed in the meantime, then the flush process can be aborted for that file. This scenario can occur for NFS based VSTOs, where the files can be removed from backend from other systems. For example, the files could have been unlinked from the ADO or renamed/moved. In such cases, the Meta Chunk VE can be marked with a flag to indicate that no flushing is required for the file. This flag can be stored in the in-memory data structure of the VE. In such cases, in step 1216, process 1200 can clear all the writeback related accounting and state information that was maintained for this particular chunk.

If the VE is a Meta Chunk and is marked to contain only Dirty Attributes and no dirty data, then we only the attributes will be flushed. This can be performed when there are no child VEs with pending writeback data. That will be ascertained by verifying that value of nflush_chunks are zero.

If one or more truncate operations had happened earlier and the Meta VE is found to be marked with FLUSH_TRUNC flag, then the Truncate operation or basically setattr call can be invoked in the beginning of the flush process itself in step 1218. This flush for truncate can be done under full resync locks on both the Cache Meta VE as well as capacity layer file (e.g. both the source and destination). Once the setattr is completes successfully, the FLUSH_TRUNC flag will be cleared off and the min_trunc_offset value can be reset to a large value. Before starting the flush, the highest offset of the file encountered till now in the flush sub-system can be recorded in the in-memory data structure of the Meta VE chunk of the current VE being flushed. It can be termed as “last_flush_offset” and updated under full lock for the cache VE.

In step 1220, once flush for the truncate operation completes, if there was any, the data flush process will begin. Step 1220 can use a full exclusive lock on the Cache VE. A Shared Range lock can be acquired on the capacity layer destination file, for the offset range corresponding to the Cache VE being flushed. This can allow a parallel flush of multiple cache VEs belonging to the same destination file, while preserving the integrity of the data.

There may also be a scenario where, the flush sub-system would have found a VE to be dirty and selected it for flushing. However, by the time the flush process actually starts after all the validation and pre-processing, the flush for this VE might have been aborted elsewhere like during unlink or rename operations. In such cases, the flush sub-system can end the process and continue to the next VE.

Once a VE is finalized for the flushing process, it can be marked as “FLUSHING” to indicate that flush has started for this VE. This flag can be stored in the in-memory data-structure of the chunk VE.

A selected VE is a Meta VE and has only dirty attributes to be flushed and no dirty unflushed data. In that case, the flush sub-system can invoke flush for the attributes only if there is no flush pending for any of its Child VEs (e.g. nflush_chunks are zero (0)). If even a single child VE is having dirty data to be flushed, then it can clear the FLUSHING flag and abort the flush process right there for the VE.

If no child VEs are marked as dirty, and the Meta VE chunk is marked to be containing dirty unflushed attributes only, then the attributes are flushed, and the FLUSHING state is cleared for the VE along with all other writeback related accounting. The flush process ends there for that VE.

Now, the final operation left is the flush of actual data in step 1222. At this point the flush sub-system can read the unflushed dirty data from the VEs on the cache VSTO and write them in their corresponding location of the destination file on the capacity layer VSTO.

The read and write operation can be implemented in sub-groups of consecutively marked dirty data i.e. for one round of flush, the read will happen for all four kilobyte (4K) data units which are consecutively marked as unflushed or dirty. And the write will then happen for the same selected 4k data units. Then again, the next consecutively marked group of 4k data units will be picked and read-write performed. This process will be repeated until all 4k data units of the selected cache VE are covered.

For optimized handling of the above I/O sub-groups in the flush process, custom designed data structure called the flush I/O request will be used. A parent flush I/O request will be created to control the child sub-I/O requests. And a child flush I/O request will be created for flushing each consecutive group of dirty four kilobyte (4k) data units. All the child flush I/O requests can be attached to the parent flush I/O request with proper reference count mechanism.

The operation of one child flush request can comprise of three (3) phases. The first one is to Read from Cache VE, second one is to write to the destination capacity layer file and finally the completion phase where the bytes have been transferred or errors encountered can be recorded in the parent flush I/O request. Eventually the child flush i/o request can be freed and the reference count of the parent I/O request decremented.

If the reference count of the parent I/O request reaches zero (0), then the final flush completion phase is initiated. In the completion phase, if the VE is a Meta Chunk and none of its child VEs are marked as dirty, then it can perform an additional flush of the attributes as well. In case, there is at least one dirty child VE, then the VE can be left marked as containing Dirty Attributes. It can then be picked up again in the next flushing cycle to flush the attributes, if all the data flush for all child VEs have completed by then.

If any errors were encountered during the Read or Write phases of any of the child I/O requests, then the flush process can be finally aborted here, so that a next retry can be done to ensure that all the dirty data has been flushed properly to the capacity layer.

If no errors were encountered, then the FLUSHING state as well as other Dirty markings will be cleared of the VE under the same locks that were used to mark them in the first place. Eventually after the reference count of the parent flush I/O request goes to zero (0), it can then be freed.

For optimizing the flush time, the data blocks on the destination VSTO's file are pre-allocated before-hand. This can ensure that the write operations triggered from the flush process are completed faster and the cache chunk VEs and the capacity layer destination file are not held under locks for a longer duration, thereby preventing newer writes in the data ranges that is being flushed. For NFS VSTOs in the capacity layer, the flush of the attributes can be done under proper owner credentials, as was done for data flush.

Writealways

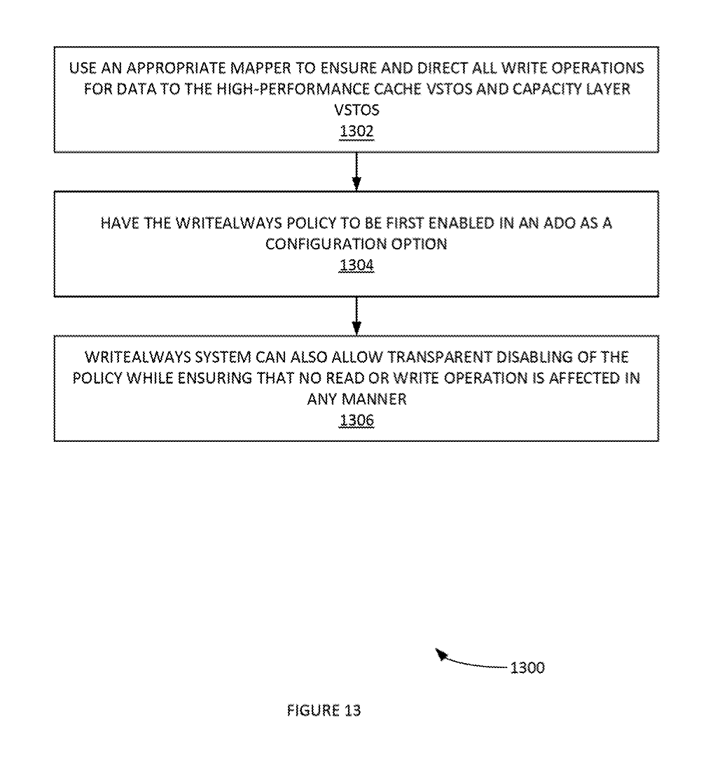

FIGS. 13 illustrates an example process 1300 of writealways based input output system and methods of an accelerated application-oriented middleware layer, according to some embodiments. In step 1302, process 1300 uses an appropriate mapper to ensure and direct all write operations for data to the high-performance Cache VSTOs and Capacity Layer VSTOs as well, irrespective of whether the same data range is already cached earlier or not. As the writes are sent to all the VSTOs, this will result in cacheifying or bringing the newly written data into Cache VSTOs as well.

In this mode, an appropriate mapper will check if the data range in the write operation is already cached or not. If it's not cached, then it will proceed by creating the corresponding VE in the cache VSTOs, if it does not exist already. And then route the write request to the cache VSTOs as well, in addition to the other Capacity Layer VSTOs. So, the newly written data will be available in all the VSTOs forming the ADO.

Conventional write-through system will only cache the read operations in the Cache VSTOs. With the writealways system, the newly written data will also now be cached in the Cache VSTOs, thereby increasing the availability of the data in the Cache VSTOs.

In step 1304, process 1300 can have the writealways policy to be first enabled in an ADO as a configuration option. This writealways policy can be defined as a Flag value in the ADO's in-memory as well as persistent on disk metadata structures. This value of the flag can then be verified by other sub-systems and method to ascertain if Writealways policy is enabled or not.

In step 1306, the writealways system can also allow transparent disabling of the policy while ensuring that no read or write operation is affected in any manner.

Nowrites

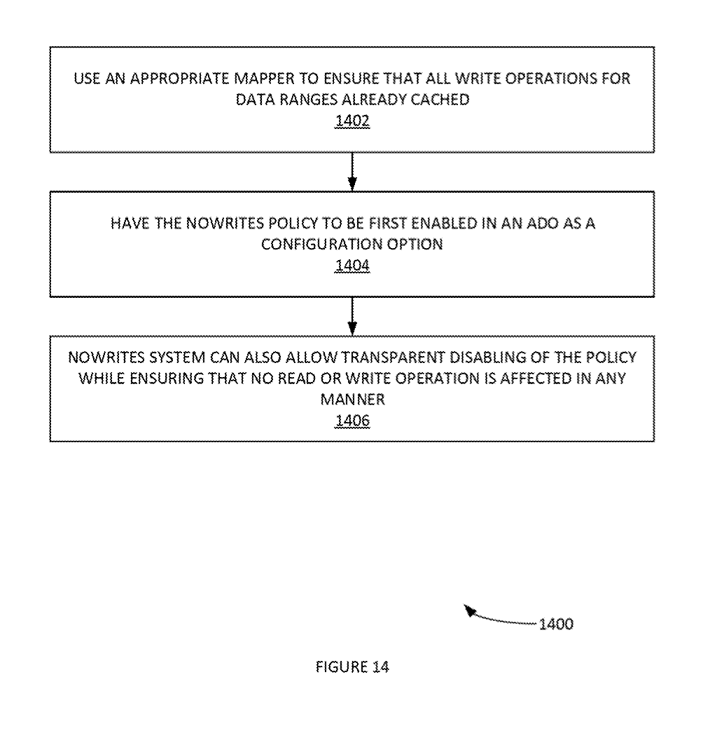

FIGS. 14 illustrates an example process 1400 of nowrites based input output system and methods of an accelerated application-oriented middleware layer, according to some embodiments. In step 1402, process 1400 uses an appropriate mapper to ensure that all write operations for data ranges already cached, result in invalidating the cached data for that range and eventually routing the write operation only to the Capacity Layer VSTOs.

After a write operation completes for already cached data range, the data range will not be available in the Cache VSTOs anymore. And for any subsequent read operations for the same data range, an appropriate mapper will ensure that it gets cached again. The data will remain in the cache VSTOs and served from the cache VSTOs until the next write operation, where it will be invalidated again.

In step 1404, process 1400 can have the nowrites policy to be first enabled in an ADO as a configuration option. This nowrites policy can be defined as a Flag value in the ADO's in-memory as well as persistent on disk metadata structures. This value of the flag can then be verified by other sub-systems and method to ascertain if Nowrites policy is enabled or not.

In step 1406, the nowrites system can also allow transparent disabling of the policy while ensuring that no read or write operation is affected in any manner.

The writeback, writealways, nowrites, writethrough and all other such systems work on individual files and directories i.e. at the File and Directory levels, thereby providing a higher level of control in the data management and placement of active data, as compared to block level solutions.

The writeback system also can maintain or prepare an inventory of the changed data and metadata set for a certain time period for a certain ADO. This data, in a customized format, can then be fed to other Backup systems or Data Migration systems for backing up or migrating only the changed dataset to other VSTOs residing in other STOs.

The policies described above, coupled with the other analytical subsystem helps in the entire management of data from provenance to deletion.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g. embodied in a machine-readable medium).

In addition, it can be appreciated that the various operations, processes, and methods disclosed herein can be embodied in a machine-readable medium and/or a machine accessible medium compatible with a data processing system (e.g. a computer system) and can be performed in any order (e.g. including using means for achieving the various operations). Accordingly, the specification and drawings are to be regarded in an illustrative rather than a restrictive sense. In some embodiments, the machine-readable medium can be a non-transitory form of machine-readable medium.

What is claimed is:

1. A computer-implemented method of an accelerated application-oriented middleware layer, the method comprising:
using an appropriate mapper to direct a write operation for data and metadata to Cache Virtual Storage Objects (VSTOs);
implementing any changes to the metadata of a data object or an iNode on a Vstobj Element (VE) of the Cache VSTOs only and acknowledging the metadata operation completion;
acknowledge the operation completion for write i/o operations and attribute write operations, as soon as they are completed in the Cache VSTOs;
maintaining an input/output (I/O) state of data and metadata as a specified number of bits of in-memory and on-disk bitmaps for each VE on the Cache VSTOs;
maintaining an identification state for each write operation as a specified number of bits of in-memory and on-disk bitmaps;
for truncate operations, the operation will be routed to the cache VSTOs only and not the other capacity layer VSTOs; and
minimum truncate offset value seen will be maintained, in the in-memory data structure of the Meta VE in the Cache VSTOs; and
appropriate mappers will refer to the min_trunc_offset value for handling various scenarios of read operations like, reads beyond the min_trunc_offset, reads on the truncate boundary itself, reads below the min_trunc_offset to name a few.
using a flushing sub-system for:
periodically detecting and flushing dirty writeback data and dirty writeback metadata from a dirty VE on the cache VSTO into a capacity storage layer VSTOs, and
optimizing the flush cycles by pre-allocating filesystem data blocks in the destination capacity layer VSTOs,
optimizing and improving the flush cycle performance by implementing range-based locking of the destination file in the capacity layer VSTOs,
providing a memory threshold protection for the system during the flush cycles; and
providing pause and resume facilities for the flush cycles;
determining that a data storage location or a VE has been designated for storing corresponding data in the cache VSTO under a writeback I/O system;
determining the actual areas of the data storage location or a VE that has been designated for storing corresponding data in the cache VSTO under a writeback I/O system,
using the appropriate mapper to differentiate between a read operation for a dirty unflushed data and a non-dirty data; and
routing the read operation for dirty unflushed data appropriately to the cache VSTOs or another non-cache or capacity layer VSTOs.
using the appropriate mapper, for a read operation comprising of a combination of dirty and non-dirty data, to:
intelligently segregating consecutive dirty and non-dirty data ranges of the read operation into individual sub-operations; and
routing the read sub-operations for the dirty and non-dirty data range to Cache VSTOs and capacity layer VSTOs respectively,
using the appropriate mapper, to route the attribute read operations to the Cache VSTOs or Capacity layer VSTOs, depending on whether the attributes are already present in the Cache VSTOs as a result of an earlier attribute read or write operation.
using an appropriate mapper to route data write operations to both Cache VSTOs and Capacity Layer VSTOs, irrespective of whether the data was already cached earlier or not; and
using an appropriate mapper to detect write operations for already cached data and then invalidate the data range in the Cache Virtual Storage Objects (VSTOs); and
route the write operation to the Capacity Layer VSTOs only.

2. The computer-implemented method of claim 1 further comprising:
optimizing an available cache eviction sub-system method to not evict an unflushed dirty data from the cache VSTOs; and
triggering a flush cycle at a specified point to lower the cache pressure value of the cache VSTOs.

3. The computer-implemented method of claim 2 further comprising:
implementing detection and removal mechanisms for a stale data by using multiple in-memory and on disk bitmaps for the i/o state and data state, wherein the stale data results after a system crash scenario.

4. The computer-implemented method of claim 3 further comprising:
optimizing the flush cycle to intelligently detect data ranges being re-written repeatedly in a selected time span; and
deferring the flush cycle for such data ranges for a specified period of time.

5. The computer-implemented method of claim 4 further comprising:
enabling and disabling a writeback subsystem dynamically at an Application Data Object (ADO) level and a global level without affecting the ongoing input output operations or without losing any dirty and unflushed data or metadata; and
enabling and disabling a writealways or nowrites subsystem dynamically at an Application Data Object (ADO) level and a global level without affecting the ongoing input output operations or without any data loss or data errors

6. The computer-implemented method of claim 4 further comprising:
using the appropriate mapper to direct a write I/O operation or attribute write operation to the cache VSTOs only; and
acknowledge completion of the operation once it is completed in the cache VSTOs.

7. The computer-implemented method of claim 1 further comprising:
using the appropriate mapper to route the write operations for data and metadata to all the Cache VSTOs available under an Application Data Object (ADO) for automatically providing high-availability and replication of the data and metadata being written; and
using the appropriate mapper to route the read operations for data and metadata to one of the available Cache VSTOs first and then to Capacity Layer VSTOs if the data or metadata is not already cached; and
use multiple algorithms (like round robin), to load balance the read operations for data and metadata among the multiple Cache VSTOs or among the multiple Capacity Layer VSTOs, to allow parallel reads from different VSTOs for getting high performance i/o.

8. The computer-implemented method of claim 2 further comprising:
implementing a writeback scratch mode for the ADO which will never flush any dirty data or metadata automatically through the flushing system; and
provide the ability to discard all the new dirty data and metadata and restore the data state from the beginning, as it was when the scratch mode was enabled; and
provide the ability to finalize or flush all the new dirty data and metadata into the capacity layer VSTOs, and thereby creating a new restore point for the subsequent new dirty data and metadata,
provide the ability to create an inventory of the dirty data and metadata and provide it to appropriate backup and data migration systems to take backups or migrating the changed dataset only.

9. The computer-implemented method of claim 1, wherein a VSTO represents an instance of using a specific storage object for various purposes, and wherein the VSTO comprises a defined interface that allows for extensible and scalable support for different data element types and protocols.

10. A computerized application or data management system for an accelerated application-oriented middleware layer comprising:
at least one processor configured to execute instructions;
a memory containing instructions when executed on the processor, causes at least one processor to perform operations that:
use an appropriate mapper to direct a write operation for data and metadata to Cache Virtual Storage Objects (VSTOs) only;
implement any changes to the metadata of a data object or an iNode on a virtual element (VE) of the Cache VSTOs;
maintain an input/output (I/O) state of data and metadata as a specified number of bits of in-memory and on-disk bitmaps for each VE on the cache VSTO;
maintaining an identification state for each write operation as a specified number of bits of in-memory and on-disk bitmaps
use a flushing sub-system to:
periodically detect and flush dirty writeback data and dirty writeback metadata from a dirty VE on the cache VSTO into capacity storage VSTOs, and
provide a memory threshold protection for the system during the flush cycles; and
provide pause and resume facilities for the flush cycles; and
optimizing the flush cycles by pre-allocating filesystem data blocks in the destination capacity layer VSTOs; and
optimizing and improving the flush cycle performance by implementing range-based locking of the destination file in the capacity layer VSTOs,
determine that a data storage location or a VE has been designated for storing corresponding data in the cache VSTO under a writeback I/O system;
determining the actual areas of the data storage location or a VE that has been designated for storing corresponding data in the cache VSTO under a writeback I/O system,
use the appropriate mapper to differentiate between a read operation for a dirty unflushed data and a non-dirty data; and
route the read operation for a dirty unflushed data appropriately to the cache VSTO or non-dirty data to another non-cache or capacity layer VSTO,
use the appropriate mapper, for a read operation comprising of a combination of dirty and non-dirty data, to:
intelligently segregate consecutive dirty and non-dirty data ranges of the read operation into individual sub-operations; and
route the read sub-operations for the dirty and non-dirty data range to Cache VSTO and capacity layer VSTO respectively,
use an appropriate mapper to route data write operations to both Cache VSTOs and Capacity Layer VSTOs, irrespective of whether the data was already cached earlier or not; and
to route read operations to one of the cache VSTOs or Capacity Layer VSTOs depending on whether the data is already cached or not.
use an appropriate mapper to detect write operations for already cached data and then invalidate the data range in the Cache Virtual Storage Objects (VSTO); and
route the write operation to the Capacity Layer VSTOs only;

11. A computer-implemented method for managing active read and write data routing and placement policy overview in an application-oriented system comprising:
when an application issues a write operation, a writeback system of the application-oriented system writes the data only in the Virtual Element (VE) of the cache Virtual Storage Objects (VSTO) and not on another capacity layer VSTO;
when an application issues an attribute write operation or metadata write operation, a writeback system of the application-oriented system executes the attribute write operation in an appropriate Meta chunk Virtual Element (VE) of the cache VSTO only and not on another capacity layer VSTO; and
persistently implementing a metadata change only in the Meta chunk VE;
when an application issues a read operation, a writeback system of the application-oriented system intelligently detects and segregates the dirty and non-dirty data ranges in the read operation and routes them to cache VSTO and capacity layer VSTO as separate read sub-operations respectively; and
when an application issues a metadata or attribute read operation, the system would route the operation to one of the Cache VSTOs or Capacity layer VSTOs depending on whether the file or inode was already cached or not.
enabling a writeback policy first in Application Data objects (ADO) as a configuration option; and
allowing a transparent disabling of the writeback policy while ensuring that no unflushed data is lost, or ongoing input/output operations are affected.
when an application issues a write operation, a writealways system of the application-oriented system writes the data to the cache Virtual Storage Objects (VSTO) as well as capacity layer VSTOs, irrespective of whether the data was already cached or not; and
allowing a transparent disabling of the writealways policy while ensuring that no read or write operation or data is affected in any manner.
when an application issues a write operation, a nowrites system of the application-oriented system detects already cached data and then invalidates them from the cache and eventually routes the write operation to the Capacity layer VSTOs only; and
allowing a transparent disabling of the nowrites policy while ensuring that no read or write operation or data is affected in any manner.
